(19) United States
(12) Patent Application Publication
(10) Pub. No.: US 2024/0051276 A1
(43) Pub. Date: Feb. 15, 2024

(54) LAMINATES, PACKAGING MATERIALS AND PACKAGING BAGS

(71) Applicant: TOPPAN INC., Tokyo (JP)

(72) Inventors: Shinya OCHIAI, Tokyo (JP); Shunichi SHIOKAWA, Tokyo (JP); Ryo TAKEI, Tokyo (JP)

(73) Assignee: TOPPAN INC., Tokyo (JP)

(21) Appl. No.: 18/383,830

(22) Filed: Oct. 25, 2023

Related U.S. Application Data
(63) Continuation of application No. PCT/JP2022/018735, filed on Apr. 25, 2022.

(30) Foreign Application Priority Data
Apr. 26, 2021 (JP) 2021-074071
Aug. 23, 2021 (JP) 2021-135563
Aug. 23, 2021 (JP) 2021-135564
Aug. 23, 2021 (JP) 2021-135565
Jan. 19, 2022 (JP) 2022-006247

(51) Int. Cl. B32B 27/08; B32B 27/32; B32B 27/16; B32B 27/34; B65D 65/40

(52) U.S. Cl. CPC B32B 27/08; B32B 27/32; B32B 27/16; B32B 27/34; B65D 65/40; B32B 2255/10; B32B 2255/26; B32B 2255/20; B32B 2255/28; B32B 2250/242; B32B 2270/00; B32B 2307/412; B32B 2307/748; B32B 2307/558; B32B 2307/7244; B32B 2307/7246; B32B 2307/518; B32B 2307/308; B32B 2307/581

(57) ABSTRACT

A laminate includes a protective layer; a substrate layer; and a sealant layer, laminated in this order, wherein the substrate layer and the sealant layer contain polyethylene, the protective layer contains a thermosetting resin or a resin having a melting point of 160° C. or higher, and a ratio of polyethylene in the laminate is 90 mass % or more.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2022/018735, filed on Apr. 25, 2022, which is based upon and claims the benefit of priority to Japanese Patent Application No. 2021-074071, filed on Apr. 26, 2021; Japanese Patent Application Nos. 2021-135563, 2021-135564, and 2021-135565, all filed on Aug. 23, 2021; and Japanese Patent Application No. 2022-006247, filed on Jan. 19, 2022, the disclosures of which are incorporated herein by reference in their entirety.

### TECHNICAL FIELD

The present disclosure relates to laminates, and packaging materials and packaging bags using the laminates. More specifically, the present disclosure relates to laminates having excellent material recyclability and a low environmental load, and packaging materials and packaging bags using the laminates.

### BACKGROUND

Packaging bags are formed of various combinations of materials depending on the nature of contents to be packed, the amount of contents, post-treatment to prevent deterioration of the contents, the method of transportation of the packaging bag, the method of unsealing the packaging bag, and the method of disposal of the packaging bag.

For example, in flexible packaging bags using laminated films, a biaxially stretched film such as polypropylene or polyester is used to provide mechanical strength to the packaging bag, and polyethylene, polypropylene, ethylene vinyl acetate copolymer, or the like is also used as a heat-sealing material of the packaging bag to seal the contents. Also, in order to prevent deterioration of the contents, an aluminum foil, an ethylene vinyl alcohol copolymer, or the like is further laminated.

The above laminate using various materials having different functions is designed focusing on suitability in each process, from packaging of the contents to transportation, storage and unsealing. However, with the growing awareness of environmental issues in recent years, functions such as resource saving and recyclability of various products are becoming important, and such functions are also required for the laminates used in the packaging bags. In general, when the main resin content in the packaging material is 90 mass % or greater, the packaging material is considered to be highly recyclable, but most conventional packaging materials contain a plurality of resin materials, and paper and metal materials in some cases, and do not meet the above standard (main resin content of 90 mass % or greater), so they are not currently recycled.

For example, in order to reduce environmental load, there have been proposed packaging bags using a laminate composed of plant-derived plastics instead of petroleum-derived plastics (see PTL 1). This reduces the usage of petroleum resources and carbon dioxide emissions. However, for recycling of the laminates composed of combinations of various materials, the materials must be separated and sorted. In this case, the materials are separated by various thermal, chemical and mechanical actions, and then sorted by a physical action based on specific gravity, a spectroscopic method different for each material, or the like, and this poses a problem that energy is consumed for recycling the materials.

Further, PTL 2 describes a multilayer film in which a gas barrier layer formed by applying a dispersion containing an inorganic layered compound and a water-soluble polymer, an overcoat layer containing a cationic resin and a resin having a hydroxyl group, an adhesive layer, and a sealant layer are laminated in sequence on at least one surface of a substrate layer made of a thermoplastic resin. The multilayer film is described as being excellent in heat-sealing properties and gas barrier properties. However, such a packaging material, in which a plurality of types of materials are combined, has difficulty in separating the materials after use. It is difficult to recycle the packaging material as a single material, and there is a problem that energy is consumed for separation and sorting of the materials as described above. Therefore, even if such multilayer films are collected after use, the only way to recycle them is to incinerate them to recover the heat, which is incompatible with recent global environmental protection measures.

PTL 3 describes a laminate including a substrate, an adhesive layer, and a heat-seal layer, in which the substrate and the heat-seal layer are made of polyethylene. Due to the substrate and the heat-seal layer being made of the same material, the above standard of recyclability can be easily satisfied.

Further, PTL 4 proposes a packaging bag having excellent anti-blocking properties and unsealing properties due to a coating layer made of resin being disposed on the outer surface of a substrate layer made of polyethylene.

[Citation List] [Patent Literature] PTL 1: JP 2019-142588 A; PTL 2: JP 2009-241359 A; PTL 3: JP 2020-55157 A; PTL 4: JP 2020-196791 A.

### SUMMARY OF THE INVENTION

### Technical Problem

When the laminate described in PTL 3 is applied to a packaging bag, a process of forming a packaging bag includes heat-sealing, in which a pressure is applied to the outer surface-side of the substrate layer of the laminate with a jig heated to high-temperatures while the heat-seal layers (sealant layers) of the laminate face each other. The jig of the heat-sealing machine is heated to high temperatures, and the outer surface-side of the substrate layer, which is in direct contact with the jig, is exposed to high temperatures. Accordingly, in the conventional laminates, the substrate layer may be affected by heat and adhere to the jig, or the heat-sealed portion may undergo wrinkling, resulting in insufficient heat-sealing properties. This poses a problem of narrow temperature range suitable for forming bags, poor productivity, and insufficient strength of packaging bags.

Further, PTL 4 proposes a simplified layer configuration, in which the sealant layer is disposed on the substrate layer, from the viewpoint of ease of recycling, and the application of the layer configuration is limited to light packaging. Accordingly, the packaging film described in PTL 4, which has insufficient strength, is difficult to apply to packaging bags for packaging liquid, which require sufficient sealing capability.

The present disclosure has an object to provide a laminate excellent in recyclability and heat-sealing properties and provide a packaging material and a packaging bag using the laminate.

### Solution to Problem

### First Aspect

In order to solve the above problems, the present disclosure provides a laminate including: a protective layer; a substrate layer; and a sealant layer, laminated in this order, wherein the substrate layer and the sealant layer contain polyethylene, the protective layer contains a thermosetting resin or a resin having a melting point of 160° C. or higher, and a ratio of polyethylene in the laminate is 90 mass % or greater.

The above laminate may include a vapor deposition layer between the substrate layer and the sealant layer.

In the above laminate, the vapor deposition layer may contain a metal oxide.

In the above laminate, the protective layer may contain at least one resin selected from the group consisting of polyurethane, polyester, polyamide, polyamideimide and epoxy.

In the above laminate, the protective layer may have a thickness of 0.4% or more and 2.0% or less of a total thickness of the laminate.

In the above laminate, at least one of the substrate layer and the sealant layer may be a layer formed of an unstretched polyethylene film.

The above laminate may include an intermediate layer between the substrate layer and the sealant layer, and the intermediate layer may contain polyethylene.

In the above laminate, the intermediate layer may contain high-density polyethylene or medium-density polyethylene.

In the above laminate, the intermediate layer may be a layer formed of an unstretched polyethylene film.

In the above laminate, the substrate layer may contain high-density polyethylene or medium-density polyethylene.

In the above laminate, the sealant layer may contain low-density polyethylene.

### Second Aspect

In order to solve the above problems, the present disclosure also provides a laminate including: a substrate layer; a first adhesive layer; an intermediate layer; a second adhesive layer; a sealant layer, laminated in this order, and a protective layer laminated on an outermost side of the substrate layer, wherein the protective layer is made of a thermosetting resin, the substrate layer is a stretched polyethylene film, the intermediate layer and the sealant layer are unstretched polyethylene films, a vapor deposition layer is disposed on one surface of the intermediate layer, and a ratio of polyethylene in the laminate is 90 wt % or more. According to such a laminate, it is possible to provide a packaging laminate having a small environmental load, which is excellent in recyclability, and excellent in barrier properties while having sufficient strength and heat resistance.

In the above laminate, the thermosetting resin may be formed of a cured product of one or more resin compositions of urethane, polyester, polyamide, acrylic, and epoxy.

In the above laminate, the vapor deposition layer may contain a metal oxide.

In the above laminate, the intermediate layer may contain high-density polyethylene or medium-density polyethylene.

In the above laminate, the substrate layer may contain high-density polyethylene or medium-density polyethylene.

In the above laminate, the sealant layer may contain low-density polyethylene.

### Third Aspect

In order to solve the above problems, the present disclosure also provides a laminate including at least a substrate layer and a sealant layer, wherein a protective layer is provided on at least one surface of the substrate layer, each of the substrate layer and the sealant layer are made of polyethylene (PE) resin, the substrate layer has a probe descending temperature of 180° C. or higher, and a ratio of polyethylene in the laminate is 90 mass % or greater. According to such a laminate, it is possible to provide a laminate having transparency and heat-sealing properties applicable to packaging materials, and excellent in recyclability.

The above laminate may further include an intermediate layer made of polyethylene (PE) resin.

In the above laminate, the intermediate layer has a probe descending temperature of 180° C. or lower. According to such a laminate, it is possible to provide a laminate having heat-sealing properties and bag-breaking strength applicable to packaging materials, and excellent in recyclability.

In the above laminate, the intermediate layer has a probe descending temperature of 180° C. or higher. According to such a laminate, it is possible to provide a laminate having heat-sealing properties and strength applicable to packaging materials, and excellent in recyclability.

When the above laminate further includes an intermediate layer made of polyethylene (PE) resin, the protective layer, the substrate layer, a first adhesive layer, the intermediate layer, a second adhesive layer, and the sealant layer may be disposed in this order, and a vapor deposition layer may be further provided on at least one surface of the intermediate layer.

Further, when the above laminate does not include an intermediate layer made of polyethylene (PE) resin, the protective layer, the substrate layer, an adhesive layer, and the sealant layer may be disposed in this order, and a vapor deposition layer may be further provided on at least one surface of the substrate layer.

In the above laminate, the vapor deposition layer may be composed of an inorganic compound layer, or composed of an inorganic compound layer and a coating layer.

In the above laminate, the coating layer may contain a hydroxyl group-containing polymer and an organosilicon compound.

In the above laminate, the protective layer may contain one or more of urethane resin, polyester resin, polyamide resin, acrylic resin, and epoxy resin, and may have a thickness of 0.3 μm or more and 3 μm or less.

The present disclosure also provides a packaging material including the laminate of the present disclosure described above, or a packaging bag using the laminate of the present disclosure described above in which the sealant layer has a thickness of 20 μm or more and 150 μm or less.

### Advantageous Effects of Invention

### First Effect

According to the first aspect, the second aspect, and the third aspect of the present disclosure, it is possible to provide a laminate excellent in recyclability and heat-sealing properties and provide a packaging material and a packaging bag using the laminate.

### Second Effect

By providing the laminate according to the second aspect of the present disclosure, it is possible to produce packaging bags that are easy to recycle the materials, excellent in strength, heat resistance and barrier properties, and have high productivity.

### Third Effect

By providing the laminate according to the third aspect of the present disclosure, in which the substrate layer and the sealant layer, or the substrate layer, the sealant layer and the intermediate layer, which are the main components, are made of polyethylene resin, it is not necessary to separate the materials for recycling, and thus the recyclability is improved. In addition, although the substrate layer is made of a polyethylene resin, which has poor heat resistance, a protective layer made of a thermosetting resin is provided on the surface of the substrate layer, whereby the heat-sealing properties are ensured, and packaging bags with high productivity can be produced. Moreover, since the probe descending temperature is used as an index, it is possible to ensure the transparency of the polyethylene substrate layer. Accordingly, the suitability for printing on the rear surface, which is required for packaging materials, can be achieved. Further, by specifying the probe descending temperature of the intermediate layer, it is possible to ensure the strength of the laminate. Also, by providing the intermediate layer with the gas barrier layer, gas barrier packaging materials can be provided. Furthermore, by providing the gas barrier layer on at least one surface of the substrate layer, gas barrier packaging materials can be provided.

### BRIEF DESCRIPTION OF THE DRAWINGS

FIG. 1 is a schematic cross-sectional view illustrating an embodiment of a laminate of the present disclosure.

FIG. 2 is a schematic cross-sectional view illustrating an embodiment of a laminate of the present disclosure.

FIG. 3 is a schematic cross-sectional view illustrating an embodiment of a laminate of the present disclosure.

FIG. 4 is a schematic cross-sectional view illustrating an embodiment of a laminate of the present disclosure.

### DETAILED DESCRIPTION

With reference to the drawings as appropriate, embodiments of the present disclosure will be described in detail. It should be noted that the present disclosure is not limited to the following embodiments.

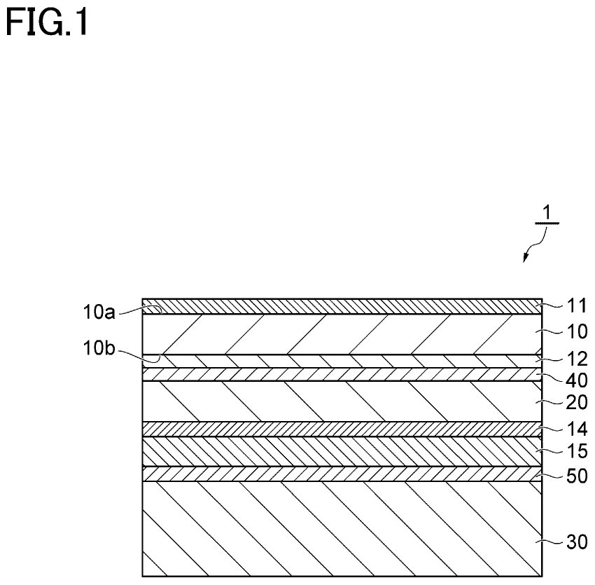

FIG. 1 is a schematic cross-sectional view illustrating an embodiment of a laminate of the present disclosure. A laminate 1 shown in FIG. 1 includes a substrate layer (substrate or substrate film) 10, a first adhesive layer 40, an intermediate layer (intermediate film) 20, a second adhesive layer 50, a sealant layer (heat sheet film) 30, a protective layer 11 on an outer surface 10a of the substrate layer 10, and a vapor deposition layer (vapor deposition film or inorganic compound layer) 14 on one surface of the intermediate layer 20. The laminate 1 further includes a print layer 12 on an inner surface 10b of the substrate layer 10, and a gas barrier coating layer (coating layer) 15 on a side of vapor deposition layer 14 opposite to that facing the intermediate layer 20. Each layer will be described below.

### Substrate Layer Constituting Laminate According to First Aspect

A substrate layer 10 constituting a laminate according to a first aspect is a layer containing polyethylene, and may be, for example, an unstretched film formed of polyethylene. The substrate layer 10 is a layer constituting an outer surface of a packaging material formed of the laminate 1. In the laminate 1 of the present embodiment, however, the outer surface of the substrate layer 10 is protected by the protective layer 11.

The substrate layer 10 can be formed using a film made of a high-density polyethylene (density 0.94 g/cm³ or more) or a medium-density polyethylene (density 0.925 g/cm³ or more, less than 0.945 g/cm³). These materials may be petroleum-derived materials or plant-derived materials, or mixtures thereof. Further, a surface of the substrate layer 10 can be subjected to an easy-adhesion treatment by a dry surface treatment such as corona treatment or atmosphere plasma treatment. Also, a multilayered unstretched polyethylene film obtained by co-extruding polyethylenes having different densities can be used as the substrate layer 10.

The substrate layer 10 preferably has a thickness of 10 μm or more and 50 μm or less, and more preferably 12 μm or more and 35 μm or less. When the substrate layer 10 has a thickness of 10 μm or more, the laminate 1 can be provided with improved strength. When the substrate layer 10 has a thickness of 50 μm or less, the laminate 1 can be provided with improved processability.

The substrate layer 10 can be produced by forming a film of polyethylene by a T-die method, a blown film extrusion method, or the like. When the substrate layer 10 is produced by a T-die method, the melt flow rate (MFR) of polyethylene is preferably 3 g/10 min or more and 20 g/10 min or less. When the MFR is 3 g/10 min or more, the laminate can be provided with improved processability. Further, when the MFR is 20 g/10 min or less, the produced substrate layer 10 can be prevented from tearing.

When the substrate layer 10 is produced by a blown film extrusion method, the MFR of polyethylene is preferably 0.5 g/10 min or more and 5 g/10 min or less. When the MFR is 0.5 g/10 min or more, the laminate can be provided with improved processability. Further, when the MFR is 5 g/10 min or less, the film formability can be improved.

The high-density polyethylene and medium-density polyethylene used as the substrate layer 10 have a melting point of approximately 120° C. to 140° C. On the other hand, the low-density polyethylene used as the sealant layer 30 described later has a melting point of approximately 90° C. to 120° C. In heat-sealing of the laminate of the substrate layer 10 and the sealant layer 30, a heat-sealing bar, which is a jig of a heat-sealing machine, is heated to approximately 130° C. to 140° C., and the sealant layer 30 is heat-sealed by heat transmitted to the sealant layer 30 through the substrate layer 10 and the intermediate layer 20, which will be described later. Since the melting point of the polyethylene constituting the substrate layer 10 is substantially the same as the temperature of the heat-sealing bar, there is a possibility that defects in appearance, such as wrinkles, and adhesion (detachment) of the substrate layer 10 to the heat-sealing bar due to heat-sealing of the substrate layer 10 may occur when the substrate layer 10 is located on the outermost surface.

### Substrate Layer Constituting Laminate According to Second Aspect

A substrate layer 10 constituting a laminate according to a second aspect is a stretched film made of polyethylene, and is a layer constituting an outer surface of a packaging material formed of the laminate 1. The substrate layer 10 may be a uniaxially stretched film or may be a biaxially stretched film. The substrate layer 10 can be formed using a film made of a high-density polyethylene (density 0.94 g/cm³ or more) or a medium-density polyethylene (density 0.925 g/cm³ or more, less than 0.945 g/cm³). These materials may be petroleum-derived materials or plant-derived materials, or mixtures thereof. Further, the film can be produced by a known production method such as casting or blown film extrusion, and a surface of the film can be subjected to an easy-adhesion treatment by a dry surface treatment such as corona treatment or atmosphere plasma treatment. Also, a multilayered stretched polyethylene film obtained by co-extruding polyethylenes having different densities can be used as the substrate layer 10. The substrate layer 10 preferably has a thickness of 10 μm or more and 50 μm or less, and more preferably 12 μm or more and 35 μm or less. When the substrate layer 10 has a thickness of 10 μm or more, the laminate 1 can be provided with improved strength. When the substrate layer 10 has a thickness of 50 μm or less, the laminate 1 can be provided with improved processability.

### Substrate Layer Constituting Laminate According to Third Aspect

A substrate layer 10 constituting a laminate according to a third aspect is made of a polyethylene resin, and is characterized in that a surface of the substrate layer has a probe descending temperature measured by the following measurement method of 180° C. or higher.

### Method of Measuring Probe Descending Temperature

Using an atomic force microscope having a nanothermal microscope composed of a cantilever with a heating mechanism, the cantilever is brought into contact with a surface of the resin substrate layer in a solid state fixed to a sample stage, and a constant force (contact force) is applied to the cantilever in a contact mode. As a voltage is applied to heat the cantilever, the surface of the sample thermally expands and lifts the cantilever. When the cantilever is further heated, the surface of the sample softens, causing a significant change in hardness. As a result, the cantilever drops into the sample surface. The rapid displacement at this time is detected. This point of displacement is the softening point, and by converting the voltage into the temperature, the softening temperature, that is, probe descending temperature is obtained.

The probe descending temperature is a temperature obtained by measuring the ascending/descending behavior of the probe by local thermal analysis. For evaluation of the probe descending temperature, an atomic force microscope having a nanothermal microscope composed of a cantilever with a heating mechanism is used. While the cantilever is brought into contact with a surface of the sample in a solid state fixed to a sample stage, a constant force (contact force) is applied to the cantilever (probe) in a contact mode. As a voltage is applied to heat the cantilever (probe), the surface of the sample thermally expands and lifts the cantilever (probe). When the cantilever (probe) is further heated, the surface of the sample softens, causing a significant change in hardness. As a result, the cantilever (probe) drops into the sample surface. The rapid displacement at this time is detected. This point of change in voltage is the probe descending start point, and by converting the voltage into the temperature, the probe descending temperature is obtained. By performing such measurement, the probe descending temperature in a local nanoscale region near the surface can be obtained.

As the atomic force microscope (AFM), an MPF-3D-SA (trade name) and a Ztherm system (trade name) manufactured by Oxford Instruments Inc. can be used. The device is not particularly limited, and Nano Thermal Analysis (trade name) series and nano IR (trade name) series manufactured by Bruker Japan K.K. can also be used. In addition, it is also possible to perform measurement by attaching Nano Thermal Analysis (trade name) to an AFM of other manufacturers. As the cantilever (probe), an AN2-200 (trade name) manufactured by Anasys Instruments Inc. is used. The cantilever is not particularly limited, and other cantilevers (probes) can also be used as long as they can sufficiently reflect laser light and apply a voltage.

The voltage range applied to the cantilever (probe) depends on the resin or the like to be measured, but is preferably 1 V to 10 V, and more preferably 3 V to 8 V for measurement with less damage to the sample and higher spatial resolution.

The measurable probe descending temperature range depends on the resin or the like to be measured, but typically, can range from room temperature such as approximately 25° C. as a measurement start temperature to approximately 400° C. as a measurement end temperature. The temperature range for calculating the probe descending temperature is preferably 25° C. or higher and 300° C. or lower.

In measurement of the probe descending temperature, heat is applied to the cantilever (probe) while applying a constant contact force. The contact force should be a force that causes contact with the sample but does not damage the surface. The cantilever (probe) preferably has a spring constant of 0.1 N/m to 3.5 N/m, and in order to perform measurement in both tapping mode and contact mode, it is preferred to use a cantilever (probe) having a spring constant of 0.5 N/m to 3.5 N/m. The contact force is preferably 0.1 V to 3.0 V.

The heating rate of the cantilever (probe) depends on the heating mechanism or the like of the cantilever (probe), but is preferably 0.1 V/sec or more and 10 V/sec or less in general. More preferably, the heating rate is 0.2 V/sec or more and 5 V/sec or less. As the surface of the sample softens, the cantilever enters the sample, whereby the needle drops. The depth that the cantilever (probe) enters the sample is preferably 3 nm to 500 nm so that the peak top of the softening curve can be recognized. The depth is preferably 3 nm to 500 nm, and is more preferably 5 nm to 100 nm, since the cantilever (probe) may be broken if it enters the sample deeply.

Although not particularly limited thereto, a probe descending start point or a probe descending temperature may also be obtained by approximating each of an expansion curve and a softening curve by an appropriate function and calculating an intersection of them. Alternatively, an analysis method in which the peak top of the displacement is regarded as a probe descending start point or a probe descending temperature may also be used. The displacement may be from a steady state to a predetermined value in expansion or softening.

In order to measure the accurate temperature of the sample, a calibration curve was prepared after the sample measurement. As calibration samples, four types, i.e., polycaprolactone (melting point: 55° C.), low-density polyethylene (LDPE, melting point: 110° C.), polypropylene (PP, melting point: 164° C.), and polyethylene terephthalate (PET, melting point: 235° C.), were used. Two measurements were performed at different measurement positions, and a calibration curve was prepared by using the average of these measurements as a probe descending temperature. Using this calibration curve, the voltage at the probe descending start point was converted into the temperature to obtain a probe descending temperature.

As a result of measurement of the probe descending temperatures of various polyethylene resins, the inventors of the present disclosure have found that the substrate layer has low haze, exhibits transparency, and ensures sufficient visibility when the probe descending temperature is 180° C. or higher, and that the transparency is further improved when the probe descending temperature is 200° C. or higher.

The above description has been given of each of the substrate layers constituting the laminates according to the first, second and third aspects, but the substrate layer 10 may have a plurality of characteristics among the characteristics of the substrate layers constituting the laminates according to the first, second and third aspects.

### Protective Layer Constituting Laminate According to First Aspect

A protective layer 11 constituting the laminate according to the first aspect is provided to prevent defects from occurring during heat-sealing in production of bags or in filling and sealing and to ensure heat-sealability. From such a role, the protective layer 11 may be provided as the outermost layer of the laminate.

The thickness of the laminate is changed according to the weight of the contents to be packed. In general, for packages of lightweight contents, the thickness is reduced in consideration of the cost, and for packaging heavy contents, the thickness is increased in consideration of the strength. With increase in thickness of the laminate, the amount of heat required to thermally melt the heat-seal surface of the sealant layer increases. Therefore, the thickness of the protective layer 11 preferably varies in proportion to the total thickness of the laminate. The ratio of the thickness of the protective layer 11 to the total thickness of the laminate is preferably 0.4% or more and 2.0% or less. When the ratio is 0.4% or more, it is easy to achieve desired heat resistance and more excellent heat-sealing properties, and when the ratio is 2.0% or less, it is possible to suppress the waste of material of the protective layer 11 and increase in the amount of heat required for heat-sealing.

The thickness of the protective layer 11 is adjusted according to the total thickness of the laminate as described above, and may be, for example, 0.1 to 5.0 μm, preferably 0.2 to 4.0 μm, more preferably 0.3 to 4.0 μm, and still more preferably 0.3 to 2.0 μm from the perspective of improving heat resistance and reducing the amount of heat required for heat-sealing.

The protective layer 11 disposed on the outer surface of the substrate layer 10 needs to have heat resistance that does not cause softening, melting, decomposition, or the like even when the protective layer 11 is heated to, for example, 140° C. during heat-sealing. Therefore, the protective layer 11 contains a thermosetting resin or a resin having a melting point of 160° C. or higher. The resin is preferably at least one resin selected from the group consisting of polyurethane, polyester, polyamide, polyamideimide and epoxy. The protective layer 11 can be formed using a coating agent containing the above resin or a raw material that generates the above resin when cured.

When the protective layer 11 is formed using a resin having a melting point of 160° C. or higher, the melting point of the resin may be 160° C. or higher, but from the perspective of achieving higher heat resistance, the melting point is preferably 180° C. or higher, and more preferably 200° C. or higher.

Examples of the method of forming the protective layer 11 include a method of applying a dispersion, in which the above resin or a raw material thereof is dispersed in water, or a coating liquid, in which the above resin or a raw material thereof is dissolved in an organic solvent, to the substrate layer 10, followed by drying (curing), and a method of forming a film by co-extrusion with the substrate layer 10 through an adhesive resin such as maleic anhydride-modified polyethylene during formation of the substrate layer 10.

Examples of the polyurethane include dispersions such as TAKELAC W and WS series manufactured by Mitsui Chemicals, Inc., ETERNACOLL series manufactured by UBE Corporation, HYDRAN series manufactured by DIC Corporation and ADEKA BONTIGHTER HUX series manufactured by ADEKA Corporation, and solvent type coating liquids such as TAKELAC E series manufactured by Mitsui Chemicals, Inc. and BURNOCK series manufactured by DIC Corporation.

Examples of the polyester include dispersions such as VYLONAL manufactured by Toyobo Co., Ltd., ARON MELT manufactured by Toagosei Co., Ltd. and ELITEL manufactured by UNITIKA LTD., and solvent type coating liquids such as BURNOCK series manufactured by DIC Corporation.

Examples of the polyamide include Nylon 6 and Nylon 12 synthesized by combinations of ω-amino acids, and Nylon 66 synthesized by combinations of diamines and dicarboxylic acids.

Examples of the polyamideimide include VYLOMAX manufactured by Toyobo Co., Ltd.

Examples of the epoxy include ADEKA NEWCOAT series manufactured by ADEKA Corporation, DENACOL series manufactured by Nagase ChemteX Corporation and jER series manufactured by Mitsubishi Chemical Corporation.

When the protective layer 11 is provided by applying and drying (curing) a coating agent, an adhesion-imparting layer may be provided on the substrate layer 10 in a range that does not impair the recyclability so that adhesion between the substrate layer 10 and the protective layer 11 is improved.

Further, when the protective layer 11 is formed by co-extrusion with polyethylene forming the substrate layer 10 through an adhesive resin during formation of the substrate layer 10, polyamide (Nylon) can be exemplified as the material of the protective layer 11. In this case, each of the polyethylene, maleic acid-modified polyethylene and polyamide can be heated to melt them and be co-extruded by a blown film extrusion method, a T-die process, or the like to form a film.

### Protective Layer Constituting Laminate According to Second Aspect

A protective layer 11 constituting the laminate according to the second aspect is made of a thermosetting resin, and the thermosetting resin can be formed by a coating agent that produces a cured product of one or more resin compositions of urethane, polyester, polyamide, acrylic, and epoxy. The thickness of the protective layer 11 may be 0.1 μm to 5.0 μm, preferably 0.2 μm to 4.0 μm, more preferably 0.3 μm to 4.0 μm, and still more preferably 0.3 μm to 2.0 μm.

### Protective Layer Constituting Laminate According to Third Aspect

A protective layer 11 constituting the laminate according to the third aspect is a thermosetting resin layer. The thermosetting resin layer is not particularly limited as long as it has heat resistance, and urethane resin, polyester resin, polyamide resin, acrylic resin and epoxy resin can be used singly or in combination. From the perspective of reducing thermal damage to a surface of the laminate during heat-sealing, facilitating drying, and improving productivity, the thickness of the protective layer 11 may be 0.1 μm to 5.0 μm, preferably 0.2 μm to 4.0 μm, more preferably 0.3 μm to 4.0 μm, and still more preferably 0.3 μm to 2.0 μm.

Due to the protective layer 11 made of a thermosetting resin being disposed on the outermost surface, the range of heat-sealing temperature in the bag-producing conditions can be expanded, preventing a decrease in productivity, even when the substrate layer 10 is made of polyethylene with poor heat resistance. In addition, the substrate layer 10 is preferably a stretched film. Due to being stretched, the elongation decreases and the printability improves.

The above description has been given of each of the protective layers constituting the laminates according to the first, second and third aspects, but the protective layer 11 may have a plurality of characteristics among the characteristics of the protective layers constituting the laminates according to the first, second and third aspects.

The print layer 12 can be formed on an outer surface 10a of the substrate layer 10 on a side on which the protective layer 11 is formed, or on an inner surface 10b on a side on which the intermediate layer 20 is laminated. By forming the print layer 12 on the inner surface 10b of the substrate layer 10, the third effect can be more easily obtained. The method of forming an image is not particularly limited, and the image can be formed by ordinary gravure printing or flexographic printing, using an ink suitable for each method. There are solvent-based ink and water-based ink, but from the environmental viewpoint, it is preferable to used water-based ink. In addition, the outer surface 10a or the inner surface 10b of the substrate layer 10 may be subjected to a surface treatment such as corona treatment or plasma treatment in order to improve adhesion of the print layer 12.

When the substrate layer 10 is a stretched film, which is excellent in transparency, the display on the print layer 12 disposed on the inner surface 10b can be suitably visible. For the transparency that ensures suitable visibility, a haze value measured in accordance with JIS K 7105 is 20% or less, and more preferably 10% or less.

In addition, considering the recycling suitability, providing the print layer 12 on the outer surface of the substrate layer 10 facilitates deinking, whereby the ink of the print layer 12 is prevented from entering the recycled polyethylene resin as a foreign substance during the recycling treatment.

### Intermediate Layer Constituting Laminate According to First Aspect

An intermediate layer 20 constituting the laminate according to the first aspect is a layer containing polyethylene, and may be, for example, an unstretched film formed of polyethylene. As the polyethylene contained in the intermediate layer 20, high-density polyethylene and medium-density polyethylene are preferred from the viewpoint of strength and heat resistance. These materials may be petroleum-derived materials or plant-derived materials, or mixtures thereof. As with the case of the substrate layer 10, a multilayered unstretched polyethylene film obtained by co-extruding polyethylenes having different densities can be used as the intermediate layer 20. Further, a surface of the intermediate layer 20 can be subjected to an easy-adhesion treatment by a dry surface treatment such as corona treatment or atmosphere plasma treatment.

The unstretched polyethylene film refers to a polyethylene film which is not subjected to stretching during film formation, and has a structure in which spherical crystals (spherulites) of approximately 10 μm to 100 μm composed of randomly folded polyethylene molecular chains are joined together by non-crystalline molecules. When a strong impact is applied to the unstretched polyethylene film, the spherulites are broken, and the molecular chains are oriented and stretched, preventing the film itself from being torn. Therefore, packaging bodies (packaging bags that are formed, filled with the contents, and then sealed) formed of a laminate in which unstretched polyethylene films as the substrate layer 10, the intermediate layer 20 and the sealant layer 30 are laminated have characteristics that they are excellent in bag-drop strength.

The intermediate layer 20 preferably has a thickness of 9 μm or more and 50 μm or less, and more preferably 12 μm or more and 30 μm or less. When the intermediate layer 20 has a thickness of 9 μm or more, the laminate can be provided with improved strength and heat resistance. When the intermediate layer 20 has a thickness of 50 μm or less, the laminate can be provided with improved processability.

The intermediate layer 20 can be produced by forming a film of polyethylene by a T-die method, a blown film extrusion method, or the like. When the intermediate layer 20 is produced by a T-die method, the melt flow rate (MFR) of polyethylene is preferably 3 g/10 min or more and 20 g/10 min or less. When the MFR is 3 g/10 min or more, the laminate can be provided with improved processability. Further, when the MFR is 20 g/10 min or less, the produced film can be prevented from tearing.

When the intermediate layer 20 is produced by a blown film extrusion method, the MFR of polyethylene is preferably 0.5 g/10 min or more and 5 g/10 min or less. When the MFR is 0.5 g/10 min or more, the laminate can be provided with improved processability. Further, when the MFR is 5 g/10 min or less, the film formability can be improved.

### Intermediate Layer Constituting Laminate According to Second Aspect

An intermediate layer 20 constituting the laminate according to the second aspect is formed of a stretched polyethylene film.

### Intermediate Layer Constituting Laminate According to Third Aspect

An intermediate layer 20 constituting the laminate according to the third aspect has good bag-breaking strength in a falling test when the probe descending temperature is 180° C. or less, and good puncture strength when the probe descending temperature is 180° C. or more.

The above description has been given of each of the intermediate layers constituting the laminates according to the first, second and third aspects, but the intermediate layer 20 may have a plurality of characteristics among the characteristics of the intermediate layers constituting the laminates according to the first, second and third aspects.

In the laminate 1, the vapor deposition layer 14 is formed on at least one surface of the intermediate layer 20. The vapor deposition layer 14 in the present embodiment is formed on a surface of the intermediate layer 20 facing the second adhesive layer 50, but may be formed on the other side. The vapor deposition layer 14 imparts oxygen barrier properties and water vapor barrier properties to the laminate 1.

The vapor deposition layer 14 may be made of, for example, a metal oxide such as aluminum oxide, silicon oxide, magnesium oxide or tin oxide. From the viewpoint of transparency and water barrier properties, the metal oxide may be selected from the group consisting of aluminum oxide, silicon oxide and magnesium oxide. Furthermore, considering the cost, the metal oxide is selected from aluminum oxide and silicon oxide. Moreover, from the viewpoint of excellent tensile stretchability during processing, the layer is more preferably made of silicon oxide. By forming the vapor deposition layer 14 as a barrier film made of a metal oxide, high barrier properties can be achieved with a very thin layer that does not affect the recyclability of the laminate 1.

Compared with the vapor deposition layer made of a metal, the vapor deposition layer made of a metal oxide has transparency, and thus has an advantage that a user who uses the packaging material formed of the laminate is less likely to misunderstand that a metal foil is used.

The film thickness of the vapor deposition layer made of aluminum oxide is preferably 5 nm or more and 30 nm or less. The film thickness of 5 nm or more can provide sufficient gas barrier properties. The film thickness of 30 nm or less can reduce occurrence of cracking caused by deformation due to internal stress of the thin film, and prevent deterioration of gas barrier properties. In addition, the film thickness exceeding 30 nm tends to increase the cost due to an increase in material usage, film formation time, or the like, which is not preferred from an economic viewpoint. From the same viewpoint as above, the film thickness of the vapor deposition layer is more preferably 7 nm or more and 15 nm or less.

The film thickness of the vapor deposition layer made of silicon oxide is preferably 10 nm or more and 50 nm or less. The film thickness of 10 nm or more can provide sufficient gas barrier properties. The film thickness of 50 nm or less can reduce occurrence of cracking caused by deformation due to internal stress of the thin film, and prevent deterioration of gas barrier properties. In addition, the film thickness exceeding 50 nm tends to increase the cost due to an increase in material usage, film formation time, or the like, which is not preferred from an economic viewpoint. From the same viewpoint as above, the film thickness of the vapor deposition layer is more preferably 20 nm or more and 40 nm or less.

The vapor deposition layer 14 can be formed by, for example, vacuum deposition. In vacuum film formation, a physical vapor deposition method or a chemical vapor deposition method can be used. Examples of the physical vapor deposition include, but are not limited to, vacuum vapor deposition, sputtering, and ion plating. Examples of the chemical vapor deposition include, but are not limited to, thermal CVD, plasma CVD, and photo CVD.

Specifically, resistance heating vacuum vapor deposition, electron beam (EB) heating vacuum vapor deposition, induction heating vacuum vapor deposition, sputtering, reactive sputtering, dual magnetron sputtering, plasma-enhanced chemical vapor deposition (PECVD), and the like are preferably used for the vacuum deposition. In view of productivity, the vacuum vapor deposition is currently most preferable. As a heating means for the vacuum vapor deposition, it is preferred to use one of electron beam heating, resistive heating, and inductive heating.

An anchor coat layer may be formed using a known anchor coating agent on a surface of the intermediate layer 20 on a side on which the vapor deposition layer 14 is formed. This improves adhesion of the vapor deposition layer made of a metal oxide. Examples of the anchor coating agent include a polyester-based polyurethane resin, polyether-based polyurethane resin, and the like. From the viewpoint of heat resistance and interlayer adhesion strength, a polyester-based polyurethane resin is preferred.

Furthermore, in order to improve adhesion to the first adhesive layer 40, the second adhesive layer 50, the vapor deposition layer 14, and the above-mentioned anchor coat layer, the corresponding surfaces of the intermediate layer 20 may be subjected to a surface treatment such as corona treatment or plasma treatment.

As the anchor coating agent, a polyvinyl alcohol-based resin may be used. The polyvinyl alcohol-based resin may be one having vinyl alcohol units obtained by saponifying vinyl ester units, and for example, polyvinyl alcohol (PVA) or ethylene-vinyl alcohol copolymer (EVOH) can be used.

When a polyvinyl alcohol-based resin is used as the anchor coating agent, examples of the method for producing the anchor coat layer include coating using a polyvinyl alcohol-based resin solution, multilayer extrusion, and the like. In the case of multilayer extrusion, the layer may be laminated through an adhesive resin such as maleic anhydride graft-modified polyethylene.

In order to improve gas barrier properties and protect the vapor deposition layer 14, the gas barrier coating layer 15 may be provided on the vapor deposition layer 14. The gas barrier coating layer 15 is not particularly limited, but may contain a hydroxyl group-containing polymer compound, and specifically may be a heat-dried product of a composition containing at least one of a hydroxyl group-containing polymer compound and a hydrolysate thereof, and at least one selected from the group consisting of a metal alkoxide, a silane coupling agent and a hydrolysate thereof. The vapor deposition layer and the gas barrier coating layer may be collectively regarded as the gas barrier layer.

The gas barrier coating layer 15 can be formed using, for example, a composition (hereinafter, referred to as an overcoat agent) obtained by adding a hydroxyl group-containing polymer compound and a metal alkoxide and/or a silane coupling agent to water or a water/alcohol mixture. The overcoat agent can be prepared by, for example, adding a metal alkoxide and/or a silane coupling agent directly or after being subjected to a treatment such as hydrolysis in advance to a solution in which a hydroxyl group-containing polymer compound as a water-soluble polymer is dissolved in an aqueous solvent (water or a water/alcohol mixture).

Examples of the hydroxyl group-containing polymer compound include polyvinyl alcohol, ethylene-vinyl alcohol copolymer, polyvinyl pyrrolidone, starch, methyl cellulose, carboxymethyl cellulose, sodium alginate, and the like. Among these, polyvinyl alcohol (PVA) is preferably used for the overcoat agent of the gas barrier coating layer due to particularly excellent gas barrier properties.

Examples of the metal alkoxide include compounds represented by the following general formula (I).

M(OR¹)ₘ(R²)ₙ₋ₘ (I)

In general formula (I), R¹ and R² are each independently a monovalent organic group having 1 to 8 carbon atoms, and are preferably an alkyl group such as a methyl group or an ethyl group. M represents an n-valent metal atom such as Si, Ti, Al or Zr. m represents an integer from 1 to n. When a plurality of R¹s or R²s are present, the R¹s or the R²s may be the same or different.

Specific examples of the metal alkoxide include tetraethoxysilane [Si(OC₂H₅)₄] and triisopropoxyaluminum [Al(O-2′-C₃H₇)₃]. Tetraethoxysilane and triisopropoxy aluminum are preferred since they are relatively stable in an aqueous solvent after hydrolysis.

Examples of the silane coupling agent include compounds represented by the following general formula (II).

Si(OR¹¹)ₚ(R¹²)₃₋ₚR¹³ (II)

In general formula (II), represents an alkyl group such as a methyl group or an ethyl group, R¹² represents a monovalent organic group such as an alkyl group, an aralkyl group, an aryl group, an alkenyl group, an alkyl group substituted with an acryloxy group, or an alkyl group substituted with a methacrylate group, R¹³ represents a monovalent organic functional group, and p represents an integer of 1 to 3. When a plurality of R¹¹s or R¹²s are present, the R¹¹s or the R¹²s may be the same or different. Examples of the monovalent organic functional group represented by R¹³ include a glycidyloxy group, an epoxy group, a mercapto group, a hydroxyl group, an amino group, an alkyl group substituted with a halogen atom, or a monovalent organic functional group containing an isocyanate group.

Specific examples of the silane coupling agent include vinyltrimethoxysilane, γ-chloropropylmethyldimethoxysilane, γ-chloropropyltrimethoxysilane, glycidoxypropyltrimethoxysilane, γ-methacryloxypropyltrimethoxysilane and γ-methacryloxypropylmethyldimethoxysilane.

The silane coupling agent may be a multimer obtained by polymerizing the compounds represented by general formula (II). The multimer is preferably a trimer, and more preferably 1,3,5-tris (3-trialkoxysilylalkyl) isocyanurate. This is a condensation product of 3-isocyanate alkyl alkoxysilane. It is known that 1,3,5-tris (3-trialkoxysilylalkyl) isocyanurate has no chemical reactivity in the isocyanate moiety, but the reactivity is ensured by the polarity of the isocyanurate moiety. Generally, like 3-isocyanate alkyl alkoxysilane, 1,3,5-tris (3-trialkoxysilylalkyl) isocyanurate is added to an adhesive or the like, and is known as an adhesion-enhancing agent. Therefore, by adding 1,3,5-tris (3-trialkoxysilylalkyl) isocyanurate to the hydroxyl group-containing polymer compound, the water resistance of the gas barrier coating layer can be improved by hydrogen bonding. While 3-isocyanate alkyl alkoxysilane has high reactivity and low liquid stability, the isocyanurate moiety of 1,3,5-tris (3-trialkoxysilylalkyl) isocyanurate is easily dispersed in an aqueous solution and stably maintains the viscosity although it is not water-soluble due to the polarity. Further, the water resistance performance of 3-isocyanate alkyl alkoxysilane is equivalent to that of 1,3,5-tris (3-trialkoxysilylalkyl) isocyanurate.

Some 1,3,5-tris (3-trialkoxysilylalkyl) isocyanurate is produced by thermal condensation of 3-isocyanate propylalkoxysilane, and may contain 3-isocyanate propylalkoxysilane from the base material, but this poses no particular problem. More preferably, the compound is 1,3,5-tris (3-trialkoxysilylpropyl) isocyanurate, and still more preferably 1,3,5-tris (3-trimethoxy silylpropyl) isocyanurate. 1,3,5-tris (3-trimethoxy silylpropyl) isocyanurate is practically advantageous since the methoxy group has a fast hydrolysis rate and compounds containing a propyl group can be obtained at a relatively low cost.

The amount of the metal alkoxide in the overcoat agent may be 1 to 4 parts by mass, preferably 2 to 3 parts by mass, relative to 1 part by mass of the hydroxyl group-containing polymer compound from the perspective of maintaining adhesion to the vapor deposition layer and gas barrier properties. Similarly, the amount of the silane coupling agent may be 0.01 to 1 part by mass, preferably 0.1 to 0.5 parts by mass, relative to 1 part by mass of the hydroxyl group-containing polymer compound. When a silane compound (alkoxysilane) is used as the metal alkoxide, the amount of silane compound (metal alkoxide and silane coupling agent) in the overcoat agent may be 1 to 4 parts by mass, preferably 2 to 3 parts by mass, relative to 1 part by mass of the hydroxyl group-containing polymer compound.

The overcoat agent may further contain, as necessary, isocyanate compounds or known additives such as a dispersant, a stabilizer, a viscosity modifier and a colorant to such an extent that the gas barrier properties are not impaired.

The overcoat agent can be applied by, for example, a coating method such as dipping, roll coating, gravure coating, reverse gravure coating, air knife coating, comma coating, die coating, screen printing, spray coating, gravure offset, or the like. The coating film formed by applying the overcoat agent can be dried by, for example, hot air drying, hot roll drying, high frequency irradiation, infrared irradiation, UV irradiation, or a combination thereof.

The temperature for drying the coating film may be, for example, 50° C. to 150° C., and preferably 70° C. to 100° C. The drying temperature within the above range can further suppress the occurrence of cracking in the vapor deposition layer and the gas barrier coating layer, ensuring excellent barrier properties.

The gas barrier coating layer may be formed using an overcoat agent containing a hydroxyl group-containing polymer compound (for example, polyvinyl alcohol-based resin) and a silane compound. If necessary, an acid catalyst, an alkali catalyst, a photopolymerization initiator, or the like may be added to the overcoat agent.

Examples of the silane compound include silane coupling agents, polysilazanes, siloxanes, and the like, and specific examples thereof include tetramethoxy silane, tetraethoxy silane, glycidoxypropyl trimethoxy silane, acryloxypropyl trimethoxy silane, hexamethyldisilazane, and the like.

The gas barrier coating layer preferably has a thickness of 50 nm to 1,000 nm, and more preferably 100 nm to 500 nm. The thickness of 50 nm or more tends to achieve more sufficient gas barrier properties in the gas barrier coating layer, and the thickness of 1,000 nm or less tends to maintain sufficient flexibility.

### Sealant Layer Constituting Laminates According to First and Third Aspects

A sealant layer 30 constituting the laminates according to the first and third aspects is made of polyethylene, and is joined by heat-sealing when a packaging material such as a packaging bag is formed using the laminate 1. The polyethylene constituting the sealant layer 30 is preferably low-density polyethylene (LDPE), linear low-density polyethylene (LLDPE) or very low-density polyethylene (VLDPE) from the viewpoint of heat-sealing properties. Further, from the viewpoint of environmental load, biomass-derived polyethylene or recycled polyethylene is preferably used for the sealant layer 30. The sealant layer 30 may be formed of an unstretched polyethylene film.

As the low-density polyethylene, polyethylene having a density of 0.900 g/cm³ or more and less than 0.925 g/cm³ can be used. As the linear low-density polyethylene, polyethylene having a density of 0.900 g/cm³ or more and less than 0.925 g/cm³ can be used. As the very low-density polyethylene, polyethylene having a density of less than 0.900 g/cm³ can be used. The sealant layer 30 can be formed using a copolymer of ethylene and other monomers as long as the properties of the laminate 1 are not impaired.

The thickness of the sealant layer 30 can be changed as appropriate according to the weight or the like of the contents to be filled in the packaging material to be produced. For example, when producing a packaging bag to be filled with contents of 1 g or more and 200 g or less, the thickness of the sealant layer 30 is preferably 20 μm to 150 μm, more preferably 20 μm to 100 μm, and still more preferably 20 μm to 60 μm. The thickness of 20 μm or more can prevent the contents in the packaging bag from leaking out due to breakage of the sealant layer 30. The thickness of 150 μm or less can improve processability of the laminate 1.

As another example, when producing a standing pouch to be filled with the contents of 50 g or more and 2,000 g or less, the thickness of the sealant layer 30 is preferably 50 μm or more and 200 μm or less. The thickness of 50 μm or more can prevent the contents in the pouch from leaking out due to breakage of the sealant layer 30. The thickness of 200 μm or less can improve processability of the laminate 1, and the thickness is more preferably 150 μm.

### Sealant Layer Constituting Laminate According to Second Aspect

A sealant layer 30 constituting the laminate according to the second aspect is formed of unstretched polyethylene.

The above description has been given of each of the sealant layers constituting the laminates according to the first, second and third aspects, but the sealant layer 30 may have a plurality of characteristics among the characteristics of the sealant layers constituting the laminates according to the first, second and third aspects.

Additives such as an antioxidant, an antistatic agent, a nucleating agent and an ultraviolet absorber may be added to the polyethylene used for the substrate layer 10, the intermediate layer 20 and the sealant layer 30.

The first adhesive layer 40 is a layer containing at least one adhesive, and is provided between the substrate layer 10 and the intermediate layer 20 to bond them to each other. The second adhesive layer 50 is a layer containing at least one adhesive, and is provided between the intermediate layer 20 and the sealant layer 30 to bond them to each other. Any adhesive such as a one-part curing type or two-part curing type urethane-based adhesive can be used for the first adhesive layer 40 and the second adhesive layer 50. These adhesives may contain a layered inorganic compound to further improve the barrier properties.

It is also possible to form the first adhesive layer 40 and the second adhesive layer 50 using an adhesive that can exhibit gas barrier properties after curing. In particular, when the adhesive layer that is in contact with the vapor deposition layer is formed using an adhesive that exhibits gas barrier properties, a decrease in gas barrier properties due to occurrence of cracking in the vapor deposition layer can be further suppressed. Accordingly, the gas barrier properties of the laminate 1 can be further improved. Examples of such a gas barrier adhesive include epoxy-based adhesives, polyester/polyurethane-based adhesives, and the like. Specific examples include “MAXIVE” manufactured by Mitsubishi Gas Chemical Company, Inc. and “Paslim” manufactured by DIC Corporation.

The thickness of the first adhesive layer 40 and the second adhesive layer 50 is preferably 0.5 μm or more and 6 μm or less, more preferably 0.8 μm or more and 5 μm or less, and still more preferably 1.0 μm or more and 4.5 μm or less. When the first adhesive layer 40 and the second adhesive layer 50 has the thickness of 0.5 μm or more, the first adhesive layer 40 and the second adhesive layer 50 can be provided with improved adhesiveness. When the first adhesive layer 40 and the second adhesive layer 50 have the thickness of 6 μm or less, the laminate 1 can be provided with improved processability.

The first adhesive layer 40 and the second adhesive layer 50 can be formed by various known methods such as direct gravure roll coating, gravure roll coating, kiss coating, reverse roll coating, fountain coating and transfer roll coating.

Since the laminate 1 of the present embodiment configured as described above is composed of the substrate layer 10, the intermediate layer 20 and the sealant layer 30 that are formed of polyethylene, the ratio of the polyethylene in the laminate 1 is 90 mass % or greater. Therefore, the laminate 1 has high recyclability. When all the substrate layer 10, the intermediate layer 20 and the sealant layer 30 are made of only polyethylene, the ratio of the polyethylene in the laminate 1 (mass %) can be calculated by the following formula (1):

(Mass of substrate layer 10+mass of intermediate layer 20+mass of sealant layer 30)/total mass of laminate 1×100 (1)

A packaging bag formed of the laminate 1 can be formed by folding a single sheet of the laminate 1 with the sealant layer 30 inside or overlapping two sheets of the laminates 1 with the sealant layer 30 inside, and heat-sealing the peripheral edges of the sealant layer 30, leaving a part through which the contents are introduced. When the laminate 1 is heat-sealed as described above while sandwiching a folded bottom film, a standing pouch can be formed. In addition, the laminate 1 can be used to form various packaging bags such as a pillow package, a four-side sealed bag, a three-side sealed bag and a gusset package. Thus, the laminate 1 can be applied to various packaging bags.

The laminate of the present disclosure, in which the protective layer 11 as the outermost layer is provided on the outer surface of the substrate layer 10 containing polyethylene, can improve heat resistance of the heat-sealed portion, can be used for producing bags under appropriate conditions, and can provide good strength and appearance required for packaging bags. Further, since the intermediate layer 20 made of an unstretched film having the vapor deposition layer 14 is combined, a packaging bag containing liquid as the content is not easily broken by an impact when dropped, whereby the strength of the packaging bag is improved.

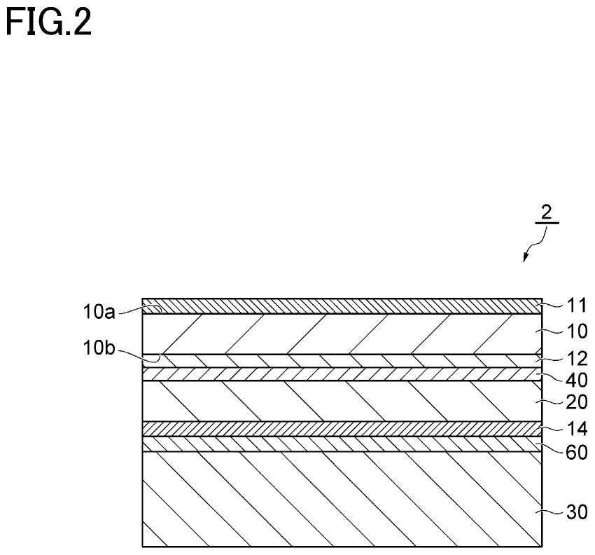

A preferred embodiment of the present disclosure has been described, but the present disclosure is not limited to the above embodiment. For example, the laminate may not necessarily include one or more of the print layer, the intermediate layer, the vapor deposition layer and the gas barrier coating layer. When the laminate does not include the intermediate layer, the first adhesive layer is not necessary, and the vapor deposition layer may be provided on the substrate layer. Further, when the laminate does not include the gas barrier coating layer, the laminate may be that shown in FIG. 2.

A laminate 2 shown in FIG. 2 is obtained by removing the gas barrier coating layer 15 from the laminate 1. The laminate 2 includes, instead of the gas barrier coating layer 15, a second adhesive layer 60 formed using an adhesive (the above-mentioned gas barrier adhesive) that exhibits gas barrier properties after curing. Accordingly, a decrease in gas barrier properties due to occurrence of cracking in the vapor deposition layer 14 can be suppressed.

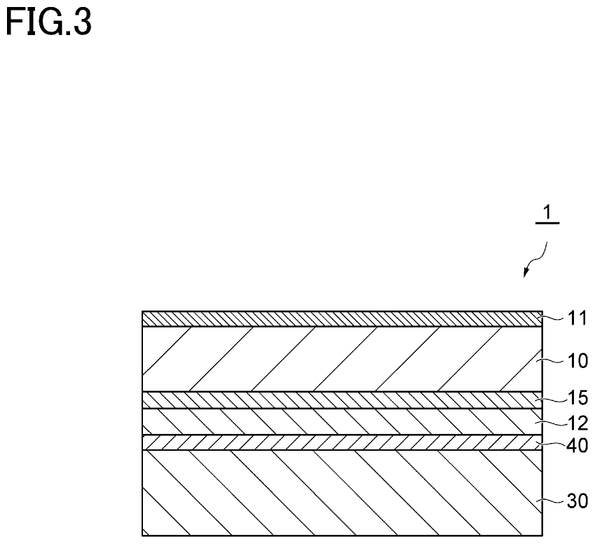

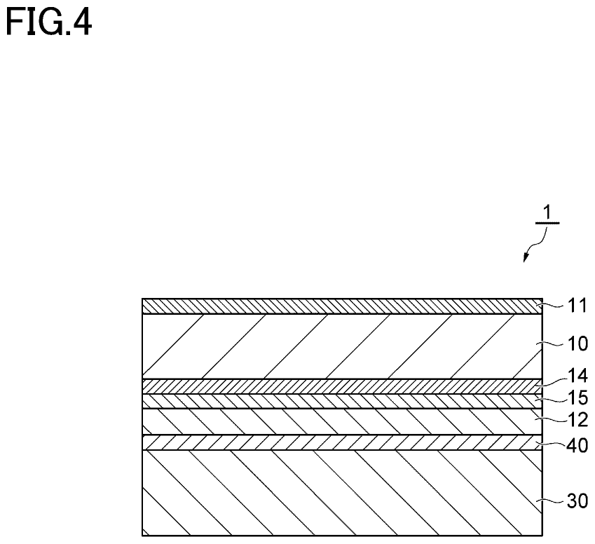

Further, a laminate according to the third aspect may have a configuration having no intermediate layer and no vapor deposition layer (inorganic compound layer) as shown in FIG. 3 or may have a configuration having no intermediate layer as shown in FIG. 4.

### EXAMPLES

The present disclosure will be described in more detail with reference to the following examples, but the present disclosure is not limited to these examples.

### Examples 1-1-1 to 1-1-5, Examples 1-2-1 to 1-2-5, Examples 1-3-1 to 1-3-5, Examples 1-4-1 to 1-4-5, Examples 1-5-1 to 1-5-5, Examples 1-6-1 to 1-6-4, Examples 1-7-1 to 1-7-4, Examples 1-8-1 to 1-8-4, Examples 1-9-1 to 1-9-4, Examples 1-10-1 to 1-10-4 and Comparative Examples 1-1 to 1-9

### Preparation of Anchor Coating Agent

Acrylic polyol and tolylene diisocyanate were mixed so that the number of NCO groups of the tolylene diisocyanate was equivalent to the number of OH groups of the acrylic polyol, and then the mixture was diluted with ethyl acetate so that the total solid content (total amount of acrylic polyol and tolylene diisocyanate) was 5 mass %. Further, β-(3,4-epoxycyclohexyl)trimethoxysilane, in an amount of 5 parts by mass relative to 100 parts by mass of the total amount of acrylic polyol and tolylene diisocyanate, was added to the diluted mixture and mixed to prepare an anchor coating agent.

### Preparation of Overcoat Agent

The following liquid A, liquid B and liquid C were mixed at a mass ratio of 70/20/10 to prepare an overcoat agent.

Liquid A: Hydrolyzed solution with a solid content of 5 mass % (equivalent to SiO₂) obtained by adding 72.1 g of 0.1N hydrochloric acid to 17.9 g of tetraethoxysilane (Si(OC₂H₅)₄) and 10 g of methanol, and stirring the mixture for 30 minutes for hydrolysis

Liquid B: Water/methanol solution containing 5 mass % of polyvinyl alcohol (water:methanol at a mass ratio of 95:5)

Liquid C: Hydrolyzed solution obtained by diluting 1,3,5-tris (3-trialkoxysilylpropyl) isocyanurate with water/isopropyl alcohol mixture solution (water:isopropyl alcohol at a mass ratio of 1:1) to a solid content of 5 mass %

### Preparation of Intermediate Film A

A 25 μm-thick unstretched polyethylene film (three-layer configuration of HDPE/MDPE/HDPE=5 μm/15 μm/5 μm) with corona treatment on both surfaces was prepared as an intermediate layer. The anchor coating agent described above was applied to one surface of the unstretched polyethylene film by gravure coating, and dried to provide an anchor coating layer of 0.1 μm thickness. Then, with an electron beam heating type vacuum vapor deposition machine, a transparent vapor deposition layer of 30 nm thickness made of a silicon oxide was formed on the anchor coat layer. The O/Si ratio of the vapor deposition layer was set to 1.8 by adjusting the type of vapor deposition material. The overcoat agent described above was applied to the vapor deposition layer by gravure coating, and dried to form a gas barrier coating layer (overcoat layer) of 0.3 μm thickness having a gas barrier function. Thus, an intermediate film A on which a vapor deposition layer made of silica was formed was obtained.

### Preparation of Intermediate Film B

The anchor coating agent was applied, by gravure coating, to one surface of an unstretched polyethylene film which was the same as the intermediate film A, and dried to provide an anchor coating layer of 0.1 μm thickness. Then, with an electron beam heating type vacuum vapor deposition machine using aluminum as a vapor deposition source, a transparent vapor deposition layer of 10 nm thickness made of an aluminum oxide was formed on the anchor coat layer. The O/Al ratio of the vapor deposition layer was set to 1.5 by adjusting the amount of oxygen introduced. Further, the overcoat agent was applied to the vapor deposition layer by gravure coating, and dried to form a gas barrier coating layer (overcoat layer) of 0.3 μm thickness having a gas barrier function. Thus, an intermediate film B on which a vapor deposition layer made of alumina was formed was obtained.

### Preparation of Intermediate Film C

An intermediate film C was obtained in the same manner as the intermediate film A except that the gas barrier coating layer was not formed.

### Preparation of Protective Layer-Forming Solution A

A coating solution for forming a protective layer made of polyurethane was prepared as follows. TAKELAC W-5030 (manufactured by Mitsui Chemicals, Inc.) was mixed with TAKENATE WD-725 (manufactured by Mitsui Chemicals, Inc.) as a curing agent at a mass ratio of 9:1, and the mixture was diluted with a solvent (water/2-propanol (IPA)=9:1 (mass ratio)) so that the non-volatile component was 5 mass % to thereby prepare a coating solution A.

### Preparation of Protective Layer-Forming Solution B

A coating solution for forming a protective layer made of polyester was prepared as follows. ELITEL KT-8803 (manufactured by UNITIKA LTD.) was mixed with Basonat HW 1000 (manufactured by BASF Corp.) as a curing agent at a mass ratio of 1:1, and the mixture was diluted with a solvent (water/2-propanol (IPA)=9:1 (mass ratio)) so that the non-volatile component was 5 mass % to thereby prepare a coating solution B.

### Preparation of Protective Layer-Forming Solution C

A coating solution for forming a protective layer made of polyamideimide was prepared as follows. VYLOMAX HR-15ET (manufactured by Toyobo Co., Ltd., melting point 300° C.) was diluted with a solvent (ethanol/toluene=1/1 (mass ratio)) so that the non-volatile component was 5 mass % to thereby prepare a coating solution C.

### Preparation of Protective Layer-Forming Solution D

A coating solution for forming a protective layer made of epoxy was prepared as follows. jER 1004 (manufactured by Mitsubishi Chemical Corporation) was mixed with CORONATE L (manufactured by Tosoh Corporation) as a curing agent at a mass ratio of 9:1, and the mixture was diluted with a solvent (ethanol/toluene=1/1 (mass ratio)) so that the non-volatile component was 5 mass % to thereby prepare a coating solution D.

### Preparation of Adhesive A

100 parts by mass of TAKELAC A525 (manufactured by Mitsui Chemicals, Inc.) was mixed with 11 parts by mass of TAKENATE A52 (manufactured by Mitsui Chemicals, Inc.) and 84 parts by mass of ethyl acetate to thereby prepare an adhesive A as a urethane-based adhesive.

### Preparation of Adhesive B

16 parts by mass of MAXIVE C93T (manufactured by Mitsubishi Gas Chemical Company, Inc.) was mixed with 5 parts by mass of MAXIVE M-100 (manufactured by Mitsubishi Gas Chemical Company, Inc.) to thereby prepare an adhesive B as an epoxy-based gas barrier adhesive.

### Example 1-1-1

A 25 μm-thick unstretched polyethylene film (three-layer configuration of EEDPE/MDPE/1-EDPE=5 μm/15 μm/5 μm) with corona treatment on both surfaces was prepared as a substrate layer. The protective layer-forming coating solution A described above was applied, by gravure coating, to the corona-treated surface on the outer surface-side of the substrate layer, and then dried and cured to form a protective layer of 0.5 μm thickness. Further, a print layer (1 μm thickness) was formed on the corona-treated surface on the inner surface-side of the substrate layer by gravure printing using a urethane-based ink. The ink was applied to the entire surface without forming an image.

Then, a surface of the substrate layer on which the print layer was formed and a corona-treated surface of the intermediate film A on which the vapor deposition layer was not formed were adhered to each other by a dry lamination method using the adhesive A. The adhesive layer was provided as a first adhesive layer. The thickness of the first adhesive layer was 3 μm.

Further, a 60 μm-thick unstretched polyethylene film with corona treatment on one surface (single-layer configuration of LLDPE) was prepared as a sealant layer. A surface of the intermediate film A facing the vapor deposition layer and a corona-treated surface of the sealant layer were adhered to each other by a dry lamination method using the adhesive A as a second adhesive layer. Thus, a laminate of Example 1-1-1 was obtained.

### Example 1-1-2

A laminate of Example 1-1-2 was obtained in the same manner as in Example 1-1-1 except that the thickness of the protective layer was 2μm and the thickness of the sealant layer was 150 μm.

### Example 1-1-3

A laminate of Example 1-1-3 was obtained in the same manner as in Example 1-1-1 except that an intermediate film B was used instead of the intermediate film A.

### Example 1-1-4

A laminate of Example 1-1-4 was obtained in the same manner as in Example 1-1-1 except that an intermediate film C was used instead of the intermediate film A, and the adhesive B was used as the second adhesive layer.

### Example 1-1-5

A laminate of Example 1-1-5 was obtained in the same manner as in Example 1-1-1 except that the thickness of the protective layer was 4 μm, a 25 μm-thick unstretched polyethylene film (three-layer configuration of HDPE/MDPE/HDPE=5 μm/15 μm/5 μm) with corona treatment on both surfaces was used as the intermediate film, and the thickness of the sealant layer was 150 μm.

### Example 1-2-1

A laminate of Example 1-2-1 was obtained in the same manner as in Example 1-1-1 except that a protective layer-forming coating solution B was used instead of the protective layer-forming coating solution A.

### Example 1-2-2

A laminate of Example 1-2-2 was obtained in the same manner as in Example 1-2-1 except that the thickness of the protective layer was 2 μm and the thickness of the sealant layer was 150 μm.

### Example 1-2-3

A laminate of Example 1-2-3 was obtained in the same manner as in Example 1-2-1 except that an intermediate film B was used instead of the intermediate film A.

### Example 1-2-4

A laminate of Example 1-2-4 was obtained in the same manner as in Example 1-2-1 except that an intermediate film C was used instead of the intermediate film A, and the adhesive B was used as the second adhesive layer.

### Example 1-2-5

A laminate of Example 1-2-5 was obtained in the same manner as in Example 1-2-1 except that the thickness of the protective layer was 4 μm, a 25 μm-thick unstretched polyethylene film (three-layer configuration of HDPE/MDPE/HDPE=5 μm/15 μm/5 μm) with corona treatment on both surfaces was used as the intermediate film, and the thickness of the sealant layer was 150 μm.

### Example 1-3-1

A polyamide/polyethylene co-extruded unstretched film (polyamide (melting point 220° C.)/maleic acid-modified polyethylene/HDPE/MDPE/HDPE=0.5 μm/0.1 μm/4.9 μm/15 μm/5 μm) (total thickness 25.5 μm) was prepared as a laminate film of the protective layer and the substrate layer. A surface of the laminate film on a side opposite to that having the polyamide was subjected to corona treatment, and a print layer (1 μm thickness) was formed thereon by gravure printing using a urethane-based ink. The ink was applied to the entire surface without forming an image. Thereafter, the same steps as in Example 1-1-1 were performed to thereby obtain a laminate of Example 1-3-1.

### Example 1-3-2

A laminate of Example 1-3-2 was obtained in the same manner as in Example 1-3-1 except that a polyamide/polyethylene co-extruded unstretched film (polyamide (melting point 220° C.)/maleic acid-modified polyethylene/HDPE/MDPE/HDPE=2 μm/0.1 μm/4.9 μm/15 μm/5 μm) (total thickness 27 μm) was used as the laminate film of the protective layer and the substrate layer, and the thickness of the sealant layer was 150 μm.

### Example 1-3-3

A laminate of Example 1-3-3 was obtained in the same manner as in Example 1-3-1 except that an intermediate film B was used instead of the intermediate film A.

### Example 1-3-4

A laminate of Example 1-3-4 was obtained in the same manner as in Example 1-3-1 except that an intermediate film C was used instead of the intermediate film A, and the adhesive B was used as the second adhesive layer.

### Example 1-3-5

A laminate of Example 1-3-5 was obtained in the same manner as in Example 1-3-1 except that a polyamide/polyethylene co-extruded unstretched film (polyamide (melting point 220° C.)/maleic acid-modified polyethylene/HDPE/MDPE/HDPE=4 μm/0.1 μm/4.9 μm/15 μm/5 μm) (total thickness 29 μm) was used as the laminate film of the protective layer and the substrate layer, a 25 μm-thick unstretched polyethylene film (three-layer configuration of 1-EDPE/MDPE/HDPE=5 μm/15 μm/5 μm) with corona treatment on both surfaces was used as the intermediate film, and the thickness of the sealant layer was 150 μm.

### Example 1-4-1

A laminate of Example 1-4-1 was obtained in the same manner as in Example 1-1-1 except that the protective layer-forming coating solution C was used instead of the protective layer-forming coating solution A.

### Example 1-4-2

A laminate of Example 1-4-2 was obtained in the same manner as in Example 1-4-1 except that the thickness of the protective layer was 2 μm and the thickness of the sealant layer was 150 μm.

### Example 1-4-3

A laminate of Example 1-4-3 was obtained in the same manner as in Example 1-4-1 except that the intermediate film B was used instead of the intermediate film A.

### Example 1-4-4

A laminate of Example 1-4-4 was obtained in the same manner as in Example 1-4-1 except that the intermediate film C was used instead of the intermediate film A, and the adhesive B was used as the second adhesive layer.

### Example 1-4-5

A laminate of Example 1-4-5 was obtained in the same manner as in Example 1-4-1 except that the thickness of the protective layer was 4 μm, a 25 μm-thick unstretched polyethylene film (three-layer configuration of HDPE/MDPE/HDPE=5 μm/15 μm/5 μm) with corona treatment on both surfaces was used as the intermediate film, and the thickness of the sealant layer was 150 μm.

### Example 1-5-1

A laminate of Example 1-5-1 was obtained in the same manner as in Example 1-5-1 except that the protective layer-forming coating solution D was used instead of the protective layer-forming coating solution A.

### Example 1-5-2

A laminate of Example 1-5-2 was obtained in the same manner as in Example 1-5-1 except that the thickness of the protective layer was 2 μm and the thickness of the sealant layer was 150 μm.

### Example 1-5-3

A laminate of Example 1-5-3 was obtained in the same manner as in Example 1-5-1 except that the intermediate film B was used instead of the intermediate film A.

### Example 1-5-4

A laminate of Example 1-5-4 was obtained in the same manner as in Example 1-5-1 except that the intermediate film C was used instead of the intermediate film A, and the adhesive B was used as the second adhesive layer.

### Example 1-5-5

A laminate of Example 1-5-5 was obtained in the same manner as in Example 1-5-1 except that the thickness of the protective layer was 4 μm, a 25 μm-thick unstretched polyethylene film (three-layer configuration of HDPE/MDPE/HDPE=5 μm/15 μm/5 μm) with corona treatment on both surfaces was used as the intermediate film, and the thickness of the sealant layer was 150 μm.

### Comparative Examples 1-1 to 1-5

Laminates of Comparative Examples 1-1 to 1-5 were obtained in the same manner as in Examples 1-1-1 to 1-1-5 except that the protective layer was not formed.

### Example 1-6-1

A 25 μm-thick unstretched polyethylene film (three-layer configuration of HDPE/MDPE/HDPE=5 μm/15 μm/5 μm) with corona treatment on both surfaces was prepared as a substrate layer. The anchor coating agent described above was applied to one surface of the substrate layer by gravure coating, and dried to provide an anchor coat layer of 0.1 μm thickness. Then, with an electron beam heating type vacuum vapor deposition machine, a transparent vapor deposition layer of 30 nm thickness made of a silicon oxide was formed on the anchor coat layer. The O/Si ratio of the vapor deposition layer was set to 1.8 by adjusting the type of vapor deposition material. The overcoat agent described above was applied to the vapor deposition layer by gravure coating, and dried to form a gas barrier coating layer (overcoat layer) of 0.3 μm thickness having a gas barrier function.

Next, the protective layer-forming coating solution A described above was applied, by gravure coating, to the corona-treated surface of the substrate layer on a side opposite to that on which the vapor deposition layer was formed, and then dried and cured to form a protective layer of 0.3 μm thickness. Further, a 20 μm-thick unstretched polyethylene film with corona treatment on one surface (single-layer configuration of LLDPE) was prepared as a sealant layer. The gas barrier coating layer and a corona-treated surface of the sealant layer were adhered to each other by a dry lamination method using the adhesive A as an adhesive layer. Thus, a laminate of Example 1-6-1 was obtained.

### Example 1-6-2

A laminate of Example 1-6-2 was obtained in the same manner as in Example 1-6-1 except that the vapor deposition layer was changed to a transparent vapor deposition layer of 10 nm thickness made of an aluminum oxide.

### Example 1-6-3

A laminate of Example 1-6-3 was obtained in the same manner as in Example 1-6-1 except that no gas barrier coating layer was provided, and the adhesive A was changed to the adhesive B described above.

### Example 1-6-4

A laminate of Example 1-6-4 was obtained in the same manner as in Example 1-6-1 except that no vapor deposition layer and no gas barrier coating layer (overcoat layer) were provided on the substrate layer.

### Example 1-7-1

A laminate of Example 1-7-1 was obtained in the same manner as in Example 1-6-1 except that the protective layer-forming coating solution B was used instead of the protective layer-forming coating solution A.

### Example 1-7-2

A laminate of Example 1-7-2 was obtained in the same manner as in Example 1-7-1 except that the vapor deposition layer was changed to a transparent vapor deposition layer of 10 nm thickness made of an aluminum oxide.

### Example 1-7-3

A laminate of Example 1-7-3 was obtained in the same manner as in Example 1-7-1 except that no gas barrier coating layer was provided, and the adhesive A was changed to the adhesive B described above.

### Example 1-7-4

A laminate of Example 1-7-4 was obtained in the same manner as in Example 1-7-1 except that no vapor deposition layer and no gas barrier coating layer (overcoat layer) were provided on the substrate layer.

### Example 1-8-1

A polyamide/polyethylene co-extruded unstretched film (polyamide (melting point 220° C.)/maleic acid-modified polyethylene/HDPE/MDPE/HDPE=0.3 μm/0.1 μm/4.9 μm/15 μm/5 μm) (total thickness 25.3 μm) was prepared as a laminate film of the protective layer and the substrate layer. A surface of the laminate film on a side opposite to that having the polyamide was subjected to corona treatment, and the anchor coating agent described above was applied to the corona-treated surface by gravure coating, and dried to provide an anchor coat layer of 0.1 μm thickness. Then, with an electron beam heating type vacuum vapor deposition machine, a transparent vapor deposition layer of 30 nm thickness made of a silicon oxide was formed on the anchor coat layer. The O/Si ratio of the vapor deposition layer was set to 1.8 by adjusting the type of vapor deposition material. The overcoat agent described above was applied to the vapor deposition layer by gravure coating, and dried to form a gas barrier coating layer (overcoat layer) of 0.3 μm thickness having a gas barrier function.

Further, a 20 μm-thick unstretched polyethylene film with corona treatment on one surface (single-layer configuration of LLDPE) was prepared as a sealant layer. The gas barrier coating layer and a corona-treated surface of the sealant layer were adhered to each other by a dry lamination method using the adhesive A as an adhesive layer. Thus, a laminate of Example 1-8-1 was obtained.

### Example 1-8-2

A laminate of Example 1-8-2 was obtained in the same manner as in Example 1-8-1 except that the vapor deposition layer was changed to a transparent vapor deposition layer of 10 nm thickness made of an aluminum oxide.

### Example 1-8-3

A laminate of Example 1-8-3 was obtained in the same manner as in Example 1-8-1 except that no gas barrier coating layer was provided, and the adhesive A was changed to the adhesive B described above.

### Example 1-8-4

A laminate of Example 1-8-4 was obtained in the same manner as in Example 1-8-1 except that no vapor deposition layer and no gas barrier coating layer (overcoat layer) were provided on the substrate layer.

### Example 1-9-1

A laminate of Example 1-9-1 was obtained in the same manner as in Example 1-6-1 except that the protective layer-forming coating solution C was used instead of the protective layer-forming coating solution A.

### Example 1-9-2

A laminate of Example 1-9-2 was obtained in the same manner as in Example 1-9-1 except that the vapor deposition layer was changed to a transparent vapor deposition layer of 10 nm thickness made of an aluminum oxide.

### Example 1-9-3

A laminate of Example 1-9-3 was obtained in the same manner as in Example 1-9-1 except that no gas barrier coating layer was provided, and the adhesive A was changed to the adhesive B described above.

### Example 1-9-4

A laminate of Example 1-9-4 was obtained in the same manner as in Example 1-9-1 except that no vapor deposition layer and no gas barrier coating layer (overcoat layer) were provided on the substrate layer.

### Example 1-10-1

A laminate of Example 1-10-1 was obtained in the same manner as in Example 1-6-1 except that the protective layer-forming coating solution D was used instead of the protective layer-forming coating solution A.

### Example 1-10-2

A laminate of Example 1-10-2 was obtained in the same manner as in Example 1-10-1 except that the vapor deposition layer was changed to a transparent vapor deposition layer of 10 nm thickness made of an aluminum oxide.

### Example 1-10-3

A laminate of Example 1-10-3 was obtained in the same manner as in Example 1-10-1 except that no gas barrier coating layer was provided, and the adhesive A was changed to the adhesive B described above.

### Example 1-10-4

A laminate of Example 1-10-4 was obtained in the same manner as in Example 1-10-1 except that no vapor deposition layer and no gas barrier coating layer (overcoat layer) were provided on the substrate layer.

### Comparative Examples 1-6 to 1-9

Laminates of Comparative Examples 1-6 to 1-9 were obtained in the same manner as in Examples 1-6-1 to 1-6-4 except that the protective layer was not formed.

### Evaluation

The laminates of the examples and comparative examples were inspected for the following evaluation. Tables 1 to 9 show the results.

### Recyclability

The ratio of polyethylene (mass %) in the laminate of each example was calculated according to the formula (1) described above. The evaluation was made using 2 grades below.
A: Content of polyethylene 90 mass % or greater
C: Content of polyethylene less than 90 mass %

### Evaluation of Heat-Sealing Properties

Each of the laminate prepared as above was cut into a 10 cm square, folded in half with the sealant layer inside, and heat-sealed with a heat seal tester under the conditions of a temperature of 140° C., a pressure of 0.1 MPa, and a heating time of 1 second. However, the heating time in Examples 1-1-2, 1-2-2, 1-3-2, 1-4-2, 1-5-2, and Comparative Example 1-2 was 3 seconds. The heat-sealed portion of the obtained sample was inspected by visual observation, and the heat-sealing properties were evaluated based on the presence or absence of adhesion of the laminate to the heat-sealing bar and the presence or absence of wrinkles in the heat-sealed portion. The evaluations were made based on the following criteria.

### (1) Adhesion to Heat-Sealing Bar

A: No melt adhesion of the laminate to the heat-sealing bar observed.
B: The laminate was slightly adhered to the heat-sealing bar, but could be separated without melt adhesion.
C: The laminate melted, and adhesion to the heat-sealing bar observed.

### (2) Wrinkles in Heat-Sealed Portion

A: No wrinkles observed in the heat-sealed portion.
C: Wrinkles observed in the heat-sealed portion.

### Impact Resistance

Using the laminate of each example, 10 packaging bags of 100 mm×150 mm with heat-sealed peripheral edges were produced. The heat-sealing was performed under the same conditions as in the evaluation of the heat-sealing properties described above. The packaging bags were filled with 200 g of distilled water, sealed by heat-sealing, and stored at 5° C. for 1 day. After the storage, the packaging bags were dropped 50 times from the height of 1.5 m, and the number of packaging bags broken was recorded.

### Oxygen Transmission Rate: OTR

The oxygen transmission rate was measured under the conditions of 30° C. and 70% RH (relative humidity) by the Mocon method. For the laminate having no vapor deposition layer, the oxygen transmission rate was not measured.

### Water Vapor Transmission Rate: WVTR

The water vapor transmission rate was measured under the conditions of 40° C. and 90% RH (relative humidity) by the Mocon method. For the laminate having no vapor deposition layer, the water vapor transmission rate was not measured.

TABLE 1

| | | Ex. 1-1-1 | Ex. 1-1-2 | Ex. 1-1-3 | Ex. 1-1-4 | Ex. 1-1-5 |
|---|---|---|---|---|---|---|
| Configura- | Protective layer | Polyurethane | Polyurethane | Polyurethane | Polyurethane | Polyurethane |
| tion of | Thickness of protective layer (μm) | 0.5 | 2.0 | 0.5 | 0.5 | 4.0 |
| each | Substrate layer | Unstretched | Unstretched | Unstretched | Unstretched | Unstretched |
| layer | Thickness of substrate layer (μm) | polyethylene | polyethylene | polyethylene | polyethylene | polyethylene |
| | | 25 | 25 | 25 | 25 | 25 |
| | Print layer | Yes | Yes | Yes | Yes | Yes |
| | Thickness of print layer (μm) | 1 | 1 | 1 | 1 | 1 |
| | First adhesive layer | Urethane- | Urethane- | Urethane- | Urethane- | Urethane- |
| | | based | based | based | based | based |
| | | adhesive | adhesive | adhesive | adhesive | adhesive |
| | Thickness of first adhesive layer (μm) | 3 | 3 | 3 | 3 | 3 |
| | Intermediate layer | Unstretched | Unstretched | Unstretched | Unstretched | Unstretched |
| | | polyethylene | polyethylene | polyethylene | polyethylene | polyethylene |
| | Thickness of intermediate layer (μm) | 25 | 25 | 25 | 25 | 25 |
| | Vapor deposition layer | Silica | Silica | Alumina | Silica | No |
| | Thickness of vapor deposition layer (μm) | 0.03 | 0.03 | 0.01 | 0.03 | 0 |
| | Gas barrier layer | Yes | Yes | Yes | No | No |
| | Thickness of gas barrier layer (μm) | 0.3 | 0.3 | 0.3 | 0 | 0 |
| | Second adhesive layer | Urethane- | Urethane- | Urethane- | Epoxy- | Urethane- |
| | | based | based | based | based | based |
| | | adhesive | adhesive | adhesive | adhesive | adhesive |
| | Thickness of second adhesive layer (μm) | 3 | 3 | 3 | 3 | 3 |
| | Sealant layer | LLDPE | LLDPE | LLDPE | LLDPE | LLDPE |
| | Thickness of sealant layer (μm) | 60 | 150 | 60 | 60 | 150 |
| | Total thickness of laminate (μm) | 117.8 | 209.3 | 117.8 | 117.5 | 211.0 |
| | Ratio of protective layer thickness to total | 0.42 | 0.96 | 0.42 | 0.43 | 1.90 |
| | thickness of laminate (%) | | | | | |
| Evaluation | Ratio of polyethylene (mass %) | 92 | 94 | 92 | 92 | 93 |
| results | Recyclability | A | A | A | A | A |
| | Adhesion to heat-sealing bar | B | B | B | B | B |
| | Wrinkles in heat-sealed portion | A | A | A | A | A |
| | Impact resistance (Number of broken bags) | 0 | 0 | 0 | 0 | 0 |
| | Oxygen transmission rate (cc/m²/day/atm) | 1.4 | 1.4 | 1.2 | 1.6 | — |
| | Water vapor transmission rate (g/m²/day) | 0.8 | 0.6 | 1.1 | 0.9 | — |

TABLE 2

| | | Ex. 1-2-1 | Ex. 1-2-2 | Ex. 1-2-3 | Ex. 1-2-4 | Ex. 1-2-5 |
|---|---|---|---|---|---|---|
| Configuration | Protective layer | Polyester | Polyester | Polyester | Polyester | Polyester |
| of each layer | Thickness of protective layer (μm) | 0.5 | 2.0 | 0.5 | 0.5 | 4.0 |
| | Substrate layer | Unstretched | Unstretched | Unstretched | Unstretched | Unstretched |
| | | polyethylene | polyethylene | polyethylene | polyethylene | polyethylene |
| | Thickness of substrate layer (μm) | 25 | 25 | 25 | 25 | 25 |
| | Print layer | Yes | Yes | Yes | Yes | Yes |
| | Thickness of print layer (μm) | 1 | 1 | 1 | 1 | 1 |
| | First adhesive layer | Urethane- | Urethane- | Urethane- | Urethane- | Urethane- |
| | | based | based | based | based | based |
| | | adhesive | adhesive | adhesive | adhesive | adhesive |
| | Thickness of first adhesive layer (μm) | 3 | 3 | 3 | 3 | 3 |
| | Intermediate layer | Unstretched | Unstretched | Unstretched | Unstretched | Unstretched |
| | | polyethylene | polyethylene | polyethylene | polyethylene | polyethylene |
| | Thickness of intermediate layer (μm) | 25 | 25 | 25 | 25 | 25 |
| | Vapor deposition layer | Silica | Silica | Alumina | Silica | No |
| | Thickness of vapor deposition layer (μm) | 0.03 | 0.03 | 0.01 | 0.03 | 0 |
| | Gas barrier layer | Yes | Yes | Yes | No | No |
| | Thickness of gas barrier layer (μm) | 0.3 | 0.3 | 0.3 | 0 | 0 |
| | Second adhesive layer | Urethane- | Urethane- | Urethane- | Epoxy- | Urethane- |
| | | based | based | based | based | based |
| | | adhesive | adhesive | adhesive | adhesive | adhesive |
| | Thickness of second adhesive layer (μm) | 3 | 3 | 3 | 3 | 3 |
| | Sealant layer | LLDPE | LLDPE | LLDPE | LLDPE | LLDPE |
| | Thickness of sealant layer (μm) | 60 | 150 | 60 | 60 | 150 |
| | Total thickness of laminate (μm) | 117.8 | 209.3 | 117.8 | 117.5 | 211.0 |
| | Ratio of protective layer thickness to total | 0.42 | 0.96 | 0.42 | 0.43 | 1.90 |
| | thickness of laminate (%) | | | | | |
| Evaluation | Ratio of polyethylene (mass %) | 92 | 94 | 92 | 92 | 93 |
| results | Recyclability | A | A | A | A | A |
| | Adhesion to heat-sealing bar | A | A | A | A | A |
| | Wrinkles in heat-sealed portion | A | A | A | A | A |
| | Impact resistance (Number of broken bags) | 0 | 0 | 0 | 0 | 0 |
| | Oxygen transmission rate (cc/m²/day/atm) | 1.4 | 1.4 | 1.2 | 1.6 | — |
| | Water vapor transmission rate (g/m²/day) | 0.8 | 0.6 | 1.1 | 0.9 | —` |

TABLE 3

| | | Ex. 1-3-1 | Ex. 1-3-2 | Ex. 1-3-3 | Ex. 1-3-4 | Ex. 1-3-5 |
|---|---|---|---|---|---|---|
| Configuration | Protective layer | Polyamide | Polyamide | Polyamide | Polyamide | Polyamide |
| of each layer | Thickness of protective layer (μm) | 0.5 | 2.0 | 0.5 | 0.5 | 4.0 |
| | Substrate layer | Unstretched | Unstretched | Unstretched | Unstretched | Unstretched |
| | | polyethylene | polyethylene | polyethylene | polyethylene | polyethylene |
| | Thickness of substrate layer (μm) | 25 | 25 | 25 | 25 | 25 |
| | Print layer | Yes | Yes | Yes | Yes | Yes |
| | Thickness of print layer (μm) | 1 | 1 | 1 | 1 | 1 |
| | First adhesive layer | Urethane- | Urethane- | Urethane- | Urethane- | Urethane- |
| | | based | based | based | based | based |
| | | adhesive | adhesive | adhesive | adhesive | adhesive |
| | Thickness of first adhesive layer (μm) | 3 | 3 | 3 | 3 | 3 |
| | Intermediate layer | Unstretched | Unstretched | Unstretched | Unstretched | Unstretched |
| | | polyethylene | polyethylene | polyethylene | polyethylene | polyethylene |
| | Thickness of intermediate layer (μm) | 25 | 25 | 25 | 25 | 25 |
| | Vapor deposition layer | Silica | Silica | Alumina | Silica | No |
| | Thickness of vapor deposition layer (μm) | 0.03 | 0.03 | 0.01 | 0.03 | 0 |
| | Gas barrier layer | Yes | Yes | Yes | No | No |
| | Thickness of gas barrier layer (μm) | 0.3 | 0.3 | 0.3 | 0 | 0 |
| | Second adhesive layer | Urethane- | Urethane- | Urethane- | Epoxy- | Urethane- |
| | | based | based | based | based | based |
| | | adhesive | adhesive | adhesive | adhesive | adhesive |
| | Thickness of second adhesive layer (μm) | 3 | 3 | 3 | 3 | 3 |
| | Sealant layer | LLDPE | LLDPE | LLDPE | LLDPE | LLDPE |
| | Thickness of sealant layer (μm) | 60 | 150 | 60 | 60 | 150 |
| | Total thickness of laminate (μm) | 117.8 | 209.3 | 117.8 | 117.5 | 211.0 |
| | Ratio of protective layer thickness to total | 0.42 | 0.96 | 0.42 | 0.43 | 1.90 |
| | thickness of laminate | | | | | |
| Evaluation | Ratio of polyethylene (mass %) | 92 | 94 | 92 | 92 | 93 |
| results | Recyclability | A | A | A | A | A |
| | Adhesion to heat-sealing bar | A | A | A | A | A |
| | Wrinkles in heat-sealed portion | A | A | A | A | A |
| | Impact resistance (Number of broken bags) | 0 | 0 | 0 | 0 | 0 |
| | Oxygen transmission rate (cc/m²/day/atm) | 1.4 | 1.4 | 1.2 | 1.6 | — |
| | Water vapor transmission rate (g/m²/day) | 0.8 | 0.6 | 1.1 | 0.9 | — |

TABLE 4

| | | Ex. 1-4-1 | Ex. 1-4-2 | Ex. 1-4-3 | Ex. 1-4-4 | Ex. 1-4-5 |
|---|---|---|---|---|---|---|
| Configuration | Protective layer | Polyamide- | Polyamide- | Polyamide- | Polyamide- | Polyamide- |
| of each layer | Thickness of protective layer (μm) | imide | imide | imide | imide | imide |
| | | 0.5 | 2.0 | 0.5 | 0.5 | 4.0 |
| | Substrate layer | Unstretched | Unstretched | Unstretched | Unstretched | Unstretched |
| | | polyethylene | polyethylene | polyethylene | polyethylene | polyethylene |
| | Thickness of substrate layer (μm) | 25 | 25 | 25 | 25 | 25 |
| | Print layer | Yes | Yes | Yes | Yes | Yes |
| | Thickness of print layer (μm) | 1 | 1 | 1 | 1 | 1 |
| | First adhesive layer | Urethane- | Urethane- | Urethane- | Urethane- | Urethane- |
| | | based | based | based | based | based |
| | | adhesive | adhesive | adhesive | adhesive | adhesive |
| | Thickness of first adhesive layer (μm) | 3 | 3 | 3 | 3 | 3 |
| | Intermediate layer | Unstretched | Unstretched | Unstretched | Unstretched | Unstretched |
| | | polyethylene | polyethylene | polyethylene | polyethylene | polyethylene |
| | Thickness of intermediate layer (μm) | 25 | 25 | 25 | 25 | 25 |
| | Vapor deposition layer | Silica | Silica | Alumina | Silica | No |
| | Thickness of vapor deposition layer (μm) | 0.03 | 0.03 | 0.01 | 0.03 | 0 |
| | Gas barrier layer | Yes | Yes | Yes | No | No |
| | Thickness of gas barrier layer (μm) | 0.3 | 0.3 | 0.3 | 0 | 0 |
| | Second adhesive layer | Urethane- | Urethane- | Urethane- | Epoxy- | Urethane- |
| | | based | based | based | based | based |
| | | adhesive | adhesive | adhesive | adhesive | adhesive |
| | Thickness of second adhesive layer (μm) | 3 | 3 | 3 | 3 | 3 |
| | Sealant layer | LLDPE | LLDPE | LLDPE | LLDPE | LLDPE |
| | Thickness of sealant layer (μm) | 60 | 150 | 60 | 60 | 150 |
| | Total thickness of laminate (μm) | 117.8 | 209.3 | 117.8 | 117.5 | 211.0 |
| | Ratio of protective layer thickness to total | 0.42 | 0.96 | 0.42 | 0.43 | 1.90 |
| | thickness of laminate (%) | | | | | |
| Evaluation | Ratio of polyethylene (mass %) | 91 | 94 | 92 | 92 | 93 |
| results | Recyclability | A | A | A | A | A |
| | Adhesion to heat-sealing bar | A | A | A | A | A |
| | Wrinkles in heat-sealed portion | A | A | A | A | A |
| | Impact resistance (Number of broken bags) | 0 | 0 | 0 | 0 | 0 |
| | Oxygen transmission rate (cc/m²/day/atm) | 1.4 | 1.4 | 1.2 | 1.6 | — |
| | Water vapor transmission rate (g/m²/day) | 0.8 | 0.6 | 1.1 | 0.9 | — |

TABLE 5

| | | Ex. 1-5-1 | Ex. 1-5-2 | Ex. 1-5-3 | Ex. 1-5-4 | Ex. 1-5-5 |
|---|---|---|---|---|---|---|
| Configuration | Protective layer | Epoxy | Epoxy | Epoxy | Epoxy | Epoxy |
| of each layer | Thickness of protective layer (μm) | 0.5 | 2.0 | 0.5 | 0.5 | 4.0 |
| | Substrate layer | Unstretched | Unstretched | Unstretched | Unstretched | Unstretched |
| | | polyethylene | polyethylene | polyethylene | polyethylene | polyethylene |
| | Thickness of substrate layer (μm) | 25 | 25 | 25 | 25 | 25 |
| | Print layer | Yes | Yes | Yes | Yes | Yes |
| | Thickness of print layer (μm) | 1 | 1 | 1 | 1 | 1 |
| | First adhesive layer | Urethane- | Urethane- | Urethane- | Urethane- | Urethane- |
| | | based | based | based | based | based |
| | | adhesive | adhesive | adhesive | adhesive | adhesive |
| | Thickness of first adhesive layer (μm) | 3 | 3 | 3 | 3 | 3 |
| | Intermediate layer | Unstretched | Unstretched | Unstretched | Unstretched | Unstretched |
| | | polyethylene | polyethylene | polyethylene | polyethylene | polyethylene |
| | Thickness of intermediate layer (μm) | 25 | 25 | 25 | 25 | 25 |
| | Vapor deposition layer | Silica | Silica | Alumina | Silica | No |
| | Thickness of vapor deposition layer (μm) | 0.03 | 0.03 | 0.01 | 0.03 | 0 |
| | Gas barrier layer | Yes | Yes | Yes | No | No |
| | Thickness of gas barrier layer (μm) | 0.3 | 0.3 | 0.3 | 0 | 0 |
| | Second adhesive layer | Urethane- | Urethane- | Urethane- | Epoxy- | Urethane- |
| | | based | based | based | based | based |
| | | adhesive | adhesive | adhesive | adhesive | adhesive |
| | Thickness of second adhesive layer (μm) | 3 | 3 | 3 | 3 | 3 |
| | Sealant layer | LLDPE | LLDPE | LLDPE | LLDPE | LLDPE |
| | Thickness of sealant layer (μm) | 60 | 150 | 60 | 60 | 150 |
| | Total thickness of laminate (μm) | 117.8 | 209.3 | 117.8 | 117.5 | 211.0 |
| | Ratio of protective layer thickness to total | 0.42 | 0.96 | 0.42 | 0.43 | 1.90 |
| | thickness of laminate (%) | | | | | |
| Evaluation | Ratio of polyethylene (mass %) | 92 | 94 | 92 | 92 | 93 |
| results | Recyclability | A | A | A | A | A |
| | Adhesion to heat-sealing bar | A | A | A | A | A |
| | Wrinkles in heat-sealed portion | A | A | A | A | A |
| | Impact resistance (Number of broken bags) | 0 | 0 | 0 | 0 | 0 |
| | Oxygen transmission rate (cc/m²/day/atm) | 1.4 | 1.4 | 1.2 | 1.6 | — |
| | Water vapor transmission rate (g/m²/day) | 0.8 | 0.6 | 1.1 | 0.9 | — |

TABLE 6

| | | Comp. | Comp. | Comp. | Comp. | Comp. |
|---|---|---|---|---|---|---|
| | | Ex. 1-1 | Ex. 1-2 | Ex. 1-3 | Ex. 1-4 | Ex. 1-5 |
| Configuration | Protective layer | No | No | No | No | No |
| of each layer | Thickness of protective layer (μm) | 0 | 0 | 0 | 0 | 0 |
| | Substrate layer | Unstretched | Unstretched | Unstretched | Unstretched | Unstretched |
| | | polyethylene | polyethylene | polyethylene | polyethylene | polyethylene |
| | Thickness of substrate layer (μm) | 25 | 25 | 25 | 25 | 25 |
| | Print layer | Yes | Yes | Yes | Yes | Yes |
| | Thickness of print layer (μm) | 1 | 1 | 1 | 1 | 1 |
| | First adhesive layer | Urethane- | Urethane- | Urethane- | Urethane- | Urethane- |
| | | based | based | based | based | based |
| | | adhesive | adhesive | adhesive | adhesive | adhesive |
| | Thickness of first adhesive layer (μm) | 3 | 3 | 3 | 3 | 3 |
| | Intermediate layer | Unstretched | Unstretched | Unstretched | Unstretched | Unstretched |
| | | polyethylene | polyethylene | polyethylene | polyethylene | polyethylene |
| | Thickness of intermediate layer (μm) | 25 | 25 | 25 | 25 | 25 |
| | Vapor deposition layer | Silica | Silica | Alumina | Silica | No |
| | Thickness of vapor deposition layer (μm) | 0.03 | 0.03 | 0.01 | 0.03 | 0 |
| | Gas barrier layer | Yes | Yes | Yes | No | No |
| | Thickness of gas barrier layer (μm) | 0.3 | 0.3 | 0.3 | 0 | 0 |
| | Second adhesive layer | Urethane- | Urethane- | Urethane- | Epoxy- | Urethane- |
| | | based | based | based | based | based |
| | | adhesive | adhesive | adhesive | adhesive | adhesive |
| | Thickness of second adhesive layer (μm) | 3 | 3 | 3 | 3 | 3 |
| | Sealant layer | LLDPE | LLDPE | LLDPE | LLDPE | LLDPE |
| | Thickness of sealant layer (μm) | 60 | 150 | 60 | 60 | 150 |
| | Total thickness of laminate (μm) | 117.3 | 207.3 | 117.3 | 117.0 | 207.0 |
| | Ratio of protective layer thickness to total | — | — | — | — | — |
| | thickness of laminate (%) | | | | | |
| Evaluation | Ratio of polyethylene (mass %) | 92 | 95 | 92 | 92 | 96 |
| results | Recyclability | A | A | A | A | A |
| | Adhesion to heat-sealing bar | C | C | C | C | C |
| | Wrinkles in heat-sealed portion | C | C | C | C | C |
| | Impact resistance (Number of broken bags) | 0 | 0 | 0 | 0 | 0 |
| | Oxygen transmission rate (cc/m²/day/atm) | 1.4 | 1.4 | 1.2 | 1.6 | — |
| | Water vapor transmission rate (g/m²/day) | 0.8 | 0.6 | 1.1 | 0.9 | — |

TABLE 7

| | | Ex. 1-6-1 | Ex. 1-6-2 | Ex. 1-6-3 | Ex. 1-6-4 | Ex. 1-7-1 | Ex. 1-7-2 | Ex. 1-7-3 | Ex. 1-7-4 |
|---|---|---|---|---|---|---|---|---|---|
| Configura- | Protective layer | Poly- | Poly- | Poly- | Poly- | Polyester | Polyester | Polyester | Polyester |
| tion of | Thickness of | urethane | urethane | urethane | urethane | 0.3 | 0.3 | 0.3 | 0.3 |
| each | protective layer | 0.3 | 0.3 | 0.3 | 0.3 | | | | |
| layer | (μm) | | | | | | | | |
| | Substrate layer | Un- | Un- | Un- | Un- | Un- | Un- | Un- | Un- |
| | | stretched | stretched | stretched | stretched | stretched | stretched | stretched | stretched |
| | | poly- | poly- | poly- | poly- | poly- | poly- | poly- | poly- |
| | | ethylene | ethylene | ethylene | ethylene | ethylene | ethylene | ethylene | ethylene |
| | Thickness of | 25 | 25 | 25 | 25 | 25 | 25 | 25 | 25 |
| | substrate layer | | | | | | | | |
| | (μm) | | | | | | | | |
| | Vapor deposition | Silica | Alumina | Silica | No | Silica | Alumina | Silica | No |
| | layer | | | | | | | | |
| | Thickness of vapor | 0.03 | 0.01 | 0.03 | 0 | 0.03 | 0.01 | 0.03 | 0 |
| | deposition layer | | | | | | | | |
| | (μm) | | | | | | | | |
| | Gas barrier layer | Yes | Yes | No | No | Yes | Yes | No | No |
| | Thickness of gas | 0.3 | 0.3 | 0 | 0 | 0.3 | 0.3 | 0 | 0 |
| | barrier layer (μm) | | | | | | | | |
| | Adhesive layer | Urethane- | Urethane- | Epoxy- | Urethane- | Urethane- | Urethane- | Epoxy- | Urethane- |
| | | based | based | based | based | based | based | based | based |
| | | adhesive | adhesive | adhesive | adhesive | adhesive | adhesive | adhesive | adhesive |
| | Thickness of | 3 | 3 | 3 | 3 | 3 | 3 | 3 | 3 |
| | adhesive layer | | | | | | | | |
| | (μm) | | | | | | | | |
| | Sealant layer | LLDPE | LLDPE | LLDPE | LLDPE | LLDPE | LLDPE | LLDPE | LLDPE |
| | Thickness of | 20 | 20 | 20 | 20 | 20 | 20 | 20 | 20 |
| | sealant layer (μm) | | | | | | | | |
| | Total thickness of | 48.6 | 48.6 | 48.3 | 48.3 | 48.6 | 48.6 | 48.3 | 48.3 |
| | laminate (μm) | | | | | | | | |
| | Ratio of protective | 0.62 | 0.62 | 0.62 | 0.62 | 0.62 | 0.62 | 0.62 | 0.62 |
| | layer thickness to | | | | | | | | |
| | total thickness of | | | | | | | | |
| | laminate (%) | | | | | | | | |
| Evaluation | Ratio of | 91 | 91 | 91 | 91 | 90 | 91 | 91 | 91 |
| results | polyethylene | | | | | | | | |
| | (mass %) | | | | | | | | |
| | Recyclability | A | A | A | A | A | A | A | A |
| | Adhesion to heat- | B | B | B | B | A | A | A | A |
| | sealing bar | | | | | | | | |
| | Wrinkles in heat- | A | A | A | A | A | A | A | A |
| | sealed portion | | | | | | | | |
| | Impact resistance | 0 | 0 | 0 | 0 | 0 | 0 | 0 | 0 |
| | (Number of broken | | | | | | | | |
| | bags) | | | | | | | | |
| | Oxygen | 1.4 | 1.2 | 1.6 | — | 1.4 | 1.2 | 1.6 | — |
| | transmission rate | | | | | | | | |
| | (cc/m²/day/atm) | | | | | | | | |
| | Water vapor | 0.9 | 1.2 | 1.0 | — | 0.9 | 1.2 | 1.0 | — |
| | transmission rate | | | | | | | | |
| | (g/m²/day) | | | | | | | | |

TABLE 8

| | | Ex. 1-8-1 | Ex. 1-8-2 | Ex. 1-8-3 | Ex. 1-8-4 | Ex. 1-9-1 | Ex. 1-9-2 | Ex. 1-9-3 | Ex. 1-9-4 |
|---|---|---|---|---|---|---|---|---|---|
| Configura- | Protective layer | Poly- | Poly- | Poly- | Poly- | Polyamide- | Polyamide- | Polyamide- | Polyamide- |
| tion of | Thickness of | amide | amide | amide | amide | imide | imide | imide | imide |
| each | protective layer | 0.3 | 0.3 | 0.3 | 0.3 | 0.3 | 0.3 | 0.3 | 0.3 |
| layer | (μm) | | | | | | | | |
| | Substrate layer | Un- | Un- | Un- | Un- | Un- | Un- | Un- | Un- |
| | | stretched | stretched | stretched | stretched | stretched | stretched | stretched | stretched |
| | | poly- | poly- | poly- | poly- | poly- | poly- | poly- | poly- |
| | | ethylene | ethylene | ethylene | ethylene | ethylene | ethylene | ethylene | ethylene |
| | Thickness of | 25 | 25 | 25 | 25 | 25 | 25 | 25 | 25 |
| | substrate layer | | | | | | | | |
| | (μm) | | | | | | | | |
| | Vapor deposition | Silica | Alumina | Silica | No | Silica | Alumina | Silica | No |
| | layer | | | | | | | | |
| | Thickness of vapor | 0.03 | 0.01 | 0.03 | 0 | 0.03 | 0.01 | 0.03 | 0 |
| | deposition layer | | | | | | | | |
| | (μm) | | | | | | | | |
| | Gas barrier layer | Yes | Yes | No | No | Yes | Yes | No | No |
| | Thickness of gas | 0.3 | 0.3 | 0 | 0 | 0.3 | 0.3 | 0 | 0 |
| | barrier layer | | | | | | | | |
| | (μm) | | | | | | | | |
| | Adhesive layer | Urethane- | Urethane- | Epoxy- | Urethane- | Urethane- | Urethane- | Epoxy- | Urethane- |
| | | based | based | based | based | based | based | based | based |
| | | adhesive | adhesive | adhesive | adhesive | adhesive | adhesive | adhesive | adhesive |
| | Thickness of | 3 | 3 | 3 | 3 | 3 | 3 | 3 | 3 |
| | adhesive layer | | | | | | | | |
| | (μm) | | | | | | | | |
| | Sealant layer | LLDPE | LLDPE | LLDPE | LLDPE | LLDPE | LLDPE | LLDPE | LLDPE |
| | Thickness of | 20 | 20 | 20 | 20 | 20 | 2 | 20 | 20 |
| | sealant layer | | | | | | | | |
| | (μm) | | | | | | | | |
| | Total thickness | 48.6 | 48.6 | 48.3 | 48.3 | 48.6 | 30.6 | 48.3 | 48.3 |
| | of laminate (μm) | | | | | | | | |
| | Ratio of | 0.62 | 0.62 | 0.62 | 0.62 | 0.62 | 0.98 | 0.62 | 0.62 |
| | protective layer | | | | | | | | |
| | thickness to total | | | | | | | | |
| | thickness of | | | | | | | | |
| | laminate (%) | | | | | | | | |
| Evaluation | Ratio of | 91 | 91 | 91 | 91 | 90 | 90 | 91 | 91 |
| results | polyethylene | | | | | | | | |
| | (mass %) | | | | | | | | |
| | Recyclability | A | A | A | A | A | A | A | A |
| | Adhesion to | A | A | A | A | A | A | A | A |
| | heat-sealing bar | | | | | | | | |
| | Wrinkles in heat- | A | A | A | A | A | A | A | A |
| | sealed portion | | | | | | | | |
| | Impact | 0 | 0 | 0 | 0 | 0 | 0 | 0 | 0 |
| | resistance | | | | | | | | |
| | (Number of | | | | | | | | |
| | broken bags) | | | | | | | | |
| | Oxygen | 1.4 | 1.2 | 1.6 | — | 1.4 | 1.2 | 1.6 | — |
| | transmission rate | | | | | | | | |
| | (cc/m²/day/atm) | | | | | | | | |
| | Water vapor | 0.9 | 1.2 | 1.0 | — | 0.9 | 1.2 | 1.0 | — |
| | transmission rate | | | | | | | | |
| | (g/m²/day) | | | | | | | | |

TABLE 9

| | | | | | | Comp. | Comp. | Comp. | Comp. |
|---|---|---|---|---|---|---|---|---|---|
| | | Ex. 1-10-1 | Ex. 1-10-2 | Ex. 1-10-3 | Ex. 1-10-4 | Ex. 1-6 | Ex. 1-7 | Ex. 1-8 | Ex. 1-9 |
| Configura- | Protective layer | Epoxy | Epoxy | Epoxy | Epoxy | No | No | No | No |
| tion of | Thickness of | 0.3 | 0.3 | 0.3 | 0.3 | 0 | 0 | 0 | 0 |
| each | protective layer | | | | | | | | |
| layer | (μm) | | | | | | | | |
| | Substrate layer | Un- | Un- | Un- | Un- | Un- | Un- | Un- | Un- |
| | | stretched | stretched | stretched | stretched | stretched | stretched | stretched | stretched |
| | | poly- | poly- | poly- | poly- | poly- | poly- | poly- | poly- |
| | | ethylene | ethylene | ethylene | ethylene | ethylene | ethylene | ethylene | ethylene |
| | Thickness of | 25 | 25 | 25 | 25 | 25 | 25 | 25 | 25 |
| | substrate layer (μm) | | | | | | | | |
| | Vapor deposition | Silica | Alumina | Silica | No | Silica | Alumina | Silica | No |
| | layer | | | | | | | | |
| | Thickness of vapor | 0.03 | 0.01 | 0.03 | 0 | 0.03 | 0.01 | 0.03 | 0 |
| | deposition layer | | | | | | | | |
| | (μm) | | | | | | | | |
| | Gas barrier layer | Yes | Yes | No | No | Yes | Yes | No | No |
| | Thickness of gas | 0.3 | 0.3 | 0 | 0 | 0.3 | 0.3 | 0 | 0 |
| | barrier layer (μm) | | | | | | | | |
| | Adhesive layer | Urethane- | Urethane- | Epoxy- | Urethane- | Urethane- | Urethane- | Epoxy- | Urethane- |
| | | based | based | based | based | based | based | based | based |
| | | adhesive | adhesive | adhesive | adhesive | adhesive | adhesive | adhesive | adhesive |
| | Thickness of | 3 | 3 | 3 | 3 | 3 | 3 | 3 | 3 |
| | adhesive layer (μm) | | | | | | | | |
| | Sealant layer | LLDPE | LLDPE | LLDPE | LLDPE | LLDPE | LLDPE | LLDPE | LLDPE |
| | Thickness of | 20 | 20 | 20 | 20 | 20 | 20 | 20 | 20 |
| | sealant layer (μm) | | | | | | | | |
| | Total thickness of | 48.6 | 48.6 | 48.3 | 48.3 | 48.3 | 48.3 | 48.0 | 48.3 |
| | laminate (μm) | | | | | | | | |
| | Ratio of protective | 0.62 | 0.62 | 0.62 | 0.62 | — | — | — | — |
| | layer thickness to | | | | | | | | |
| | total thickness of | | | | | | | | |
| | laminate (%) | | | | | | | | |
| Evaluation | Ratio of | 91 | 91 | 91 | 91 | 91 | 91 | 92 | 92 |
| results | polyethylene | | | | | | | | |
| | (mass %) | | | | | | | | |
| | Recyclability | A | A | A | A | A | A | A | A |
| | Adhesion to heat- | A | A | A | A | C | C | C | C |
| | sealing bar | | | | | | | | |
| | Wrinkles in heat- | A | A | A | A | C | C | C | C |
| | sealed portion | | | | | | | | |
| | Impact resistance | 0 | 0 | 0 | 0 | 0 | 0 | 0 | 0 |
| | (Number of broken | | | | | | | | |
| | bags) | | | | | | | | |
| | Oxygen | 1.4 | 1.2 | 1.6 | — | 1.4 | 1.2 | 1.6 | — |
| | transmission rate | | | | | | | | |
| | (cc/m²/day/atm) | | | | | | | | |
| | Water vapor | 0.9 | 1.2 | 1.0 | — | 0.9 | 1.2 | 1.0 | — |
| | transmission rate | | | | | | | | |
| | (g/m²/day) | | | | | | | | |

As shown in Tables 1 to 9, all the examples and comparative examples had high recyclability, and were excellent in impact resistance and gas barrier properties, but the laminate of the comparative example having no protective layer had poor heat-sealing properties.

### Examples 2-1 to 2-2 and Comparative Examples 2-1 to 2-2

### Preparation of Anchor Coating Agent

Acrylic polyol and tolylene diisocyanate were mixed so that the number of NCO groups of the tolylene diisocyanate was equivalent to the number of OH groups of the acrylic polyol, and then the mixture was diluted with ethyl acetate so that the total solid content (total amount of acrylic polyol and tolylene diisocyanate) was 5 mass %. Further, β-(3,4-epoxycyclohexyl)trimethoxysilane, in an amount of 5 parts by mass relative to 100 parts by mass of the total amount of acrylic polyol and tolylene diisocyanate, was added to the diluted mixture and mixed to prepare an anchor coating agent.

### Preparation of Overcoat Agent

The following liquid A, liquid B and liquid C were mixed at a mass ratio of 70/20/10 to prepare an overcoat agent.
Liquid A: Hydrolyzed solution with a solid content of 5 mass % (equivalent to SiO₂) obtained by adding 72.1 g of 0.1N hydrochloric acid to 17.9 g of tetraethoxysilane (Si(OC₂H₅)₄) and 10 g of methanol, and stirring the mixture for 30 minutes for hydrolysis
Liquid B: Water/methanol solution containing 5 mass % of polyvinyl alcohol (water:methanol at a mass ratio of 95:5)
Liquid C: Hydrolyzed solution obtained by diluting 1,3,5-tris (3-trialkoxysilylpropyl) isocyanurate with water/isopropyl alcohol mixture solution (water:isopropyl alcohol at a mass ratio of 1:1) to a solid content of 5 mass %

### Preparation of Intermediate Film A

A 25 μm-thick unstretched polyethylene film (three-layer configuration of HDPE/MDPE/HDPE=5 μm/15 μm/5 μm) with corona treatment on both surfaces was prepared as an intermediate layer. The anchor coating agent described above was applied to one surface of the unstretched polyethylene film by gravure coating, and dried to provide an anchor coating layer of 0.1 μm thickness. Then, with an electron beam heating type vacuum vapor deposition machine, a transparent vapor deposition layer of 30 nm thickness made of a silicon oxide was formed on the anchor coat layer. The O/Si ratio of the vapor deposition layer was set to 1.8 by adjusting the type of vapor deposition material. The overcoat agent described above was applied to the vapor deposition layer by gravure coating, and dried to form a gas barrier coating layer (overcoat layer) of 0.3 μm thickness having a gas barrier function. Thus, an intermediate film A on which a vapor deposition layer made of silica was formed was obtained.

### Preparation of Intermediate Film B

The anchor coating agent was applied, by gravure coating, to one surface of an unstretched polyethylene film which was the same as the intermediate film A, and dried to provide an anchor coating layer of 0.1 μm thickness. Then, with an electron beam heating type vacuum vapor deposition machine using aluminum as a vapor deposition source, a transparent vapor deposition layer of 10 nm thickness made of an aluminum oxide was formed on the anchor coat layer. The O/Al ratio of the vapor deposition layer was set to 1.5 by adjusting the amount of oxygen introduced. Further, the overcoat agent was applied to the vapor deposition layer by gravure coating, and dried to form a gas barrier coating layer (overcoat layer) of 0.3 μm thickness having a gas barrier function. Thus, an intermediate film B on which a vapor deposition layer made of alumina was formed was obtained.

### Preparation of Intermediate Film D

An intermediate film D was obtained in the same manner as the intermediate film A except that a biaxially stretched polyethylene film was used instead of the non-axially unstretched polyethylene film.

### Preparation of Protective Layer-Forming Solution C

A coating solution for forming a protective layer made of polyamideimide was prepared as follows. VYLOMAX HR-15ET (manufactured by Toyobo Co., Ltd., melting point 300° C.) was diluted with a solvent (ethanol/toluene=1/1 (mass ratio)) so that the non-volatile component was 5 mass % to thereby prepare a coating solution C.

### Example 2-1

A 25 μm-thick biaxially stretched polyethylene film (three-layer configuration of HDPE/MDPE/HDPE=5 μm/15 μm/5 μm) with corona treatment on both surfaces was prepared as a substrate layer. The protective layer-forming coating solution C described above was applied, by gravure coating, to the corona-treated surface on the outer surface-side of the substrate layer, and then dried and cured to form a protective layer of 0.5 μm thickness. Further, an image was formed on the corona-treated surface on the inner surface-side of the substrate layer by flexographic printing using water-based flexographic ink.

Then, a surface of the substrate layer on which the print layer was formed and a corona-treated surface of the intermediate film A on which the vapor deposition layer was not formed were adhered to each other by a non-solvent lamination method using a two-part curing type urethane-based adhesive. The adhesive layer was provided as a first adhesive layer.

Further, a 40 μm-thick unstretched polyethylene film (single-layer configuration of LLDPE) was prepared as a sealant layer. A surface of the intermediate film A facing the vapor deposition layer and the sealant layer were adhered to each other by a non-solvent lamination method using a two-part curing type urethane-based adhesive as a second adhesive layer. Thus, a laminate of Example 2-1 was obtained.

### Example 2-2

A laminate of Example 2-2 was obtained in the same manner as in Example 2-1 except that the intermediate film B was used instead of the intermediate film A.

### Comparative Example 2-1

A laminate of Comparative Example 2-1 was obtained in the same manner as in Example 2-1 except that no protective layer was formed, and the intermediate film D was used instead of the intermediate film A.

### Comparative Example 2-2

A laminate of Comparative Example 2-2 was obtained in the same manner as in Example 2-1 except that a 25 μm-thick unstretched polyethylene film (three-layer configuration of HDPE/MDPE/HDPE) with corona treatment on one surface was used as the substrate layer, no protective layer was formed, and the intermediate film D was used instead of the intermediate film A.

### Evaluation

The laminates of the examples and comparative examples were inspected for the following evaluation. Table 10 shows the results.

### Recyclability

The ratio of polyethylene (mass %) in the laminate of each example was calculated according to the formula (1) described above. The evaluation was made using 2 grades below.
A: Content of polyethylene 90 mass % or greater
C: Content of polyethylene less than 90 mass %

### Evaluation of Heat-Sealing Properties

Each of the laminate prepared as above was cut into a 10 cm square, folded in half with the sealant layer inside, and heat-sealed with a heat seal tester under the conditions of a temperature of 140° C., a pressure of 0.1 MPa, and a heating time of 1 second. The heat-sealed portion of the obtained sample was inspected by visual observation, and the heat-sealing properties were evaluated based on the presence or absence of adhesion of the laminate to the heat-sealing bar and the presence or absence of wrinkles in the heat-sealed portion. The evaluations were made based on the following criteria.

### (1) Adhesion to Heat-Sealing Bar and Wrinkles

A: No wrinkles in the heat-sealed portion observed, and no melt adhesion of the laminate to the heat-sealing bar observed.
C: Wrinkles in the heat-sealed portion observed, and melt adhesion of the laminate to the heat-sealing bar observed.

### Puncture Strength

Puncture strength was measured according to JIS Z 1707:2019. While the laminate of each example was held flat under tension, a needle with a 1.0 mm diameter and a hemispherical tip of 0.5 mm radius was pressed against the substrate-side of the laminate at 50 mm/min to measure the amount of force (Newton: N) when piercing the laminate.

### Impact Resistance

Using the laminate of each example, 10 packaging bags of 100 mm×150 mm with heat-sealed peripheral edges were produced. The heat-sealing was performed under the same conditions as in the evaluation of the heat-sealing properties described above. The packaging bags were filled with 200 g of distilled water, sealed by heat-sealing, and stored at 5° C. for 1 day. After the storage, the packaging bags were dropped 50 times from the height of 1.5 m, and the number of packaging bags broken was recorded.

### Oxygen Transmission Rate: OTR

The oxygen transmission rate was measured under the conditions of 30° C. and 70% RH (relative humidity) by the Mocon method. For the laminate having no vapor deposition layer, the oxygen transmission rate was not measured.

### Water Vapor Transmission Rate: WVTR

The water vapor transmission rate was measured under the conditions of 40° C. and 90% RH (relative humidity) by the Mocon method. For the laminate having no vapor deposition layer, the water vapor transmission rate was not measured.

TABLE 10

| | | Ex. 2-1 | Ex. 2-2 | Comp. Ex. 2-1 | Comp. Ex. 2-2 |
|---|---|---|---|---|---|
| Configuration | Protective layer | Yes | Yes | No | No |
| of each layer | Substrate layer | Biaxially stretched | Biaxially stretched | Biaxially stretched | Unstretched |
| | | polyethylene | polyethylene | polyethylene | polyethylene |
| | Intermediate layer | A (Unstretched | B (Unstretched | D (Biaxially stretched | D (Biaxially stretched |
| | | polyethylene) | polyethylene) | polyethylene) | polyethylene) |
| | Vapor deposition layer | Silica | Alumina | Silica | Silica |
| Evaluation | Recyclability | A | A | A | A |
| results | Ratio of polyethylene (mass %) | 92 | 92 | 92 | 92 |
| | Sealability | A | A | C | C |
| | Puncture strength (N) | 8.7 | 8.7 | 9.5 | 7.1 |
| | Impact resistance (Number of | 0 | 0 | 8 | 7 |
| | broken bags) | | | | |
| | Oxygen transmission rate | 1.4 | 1.4 | 3.0 | 3.0 |
| | (cc/m²/day/atm) | | | | |
| | Water vapor transmission rate | 0.8 | 0.8 | 1.0 | 1.0 |
| | (g/m²/day) | | | | |

As shown in Table 10, all the examples and comparative examples had high recyclability. However, the laminates of Comparative Examples 2-1 and 2-2 having no protective layer had poor heat-sealing properties, and the laminates of Comparative Examples 2-1 and 2-2 having the intermediate film formed of a stretched polyethylene film were insufficient in impact resistance.

### Examples 3-1 to 3-3 and Comparative Examples 3-1 to 3-2

### Example 3-1

The outer surface-side of a polyethylene film (SMUQ manufactured by TOKYO PRINTING INK MFG. CO., LTD., 25 μm thickness), which was a substrate layer, having a probe descending temperature of 180° C. or higher was subjected to corona treatment, and then coated with polyamideimide resin (VYLOMAX HR-15ET manufactured by Toyobo Co., Ltd.) to form a protective layer of 0.5 μm thickness. The concentration of non-volatile components was 5 mass %. Then, a hybrid organic/inorganic coating solution was applied to a surface of the substrate layer on a side opposite to that having the protective layer to form a coating layer of 0.3 μm thickness. Thereafter, an image was printed using gravure ink to form a print layer. The probe descending temperature of the substrate layer was 203° C.

A dry lamination adhesive (TAKELAC A525/TAKENATE A52 manufactured by Mitsui Chemicals, Inc.) was applied to the print layer surface on the substrate layer, and a linear low-density polyethylene resin (LLDPE) film (TUX manufactured by Mitsui Chemicals Tohcello, Inc., 60 μm thickness) as a sealant layer was bonded thereto to thereby form a laminate.

### Method for Measuring Probe Descending Temperature in Examples

Details of the measurement conditions were as follows. MPF-3D-SA (trade name) manufactured by Oxford Instruments Inc. was used as the atomic force microscope, in which a Ztherm (trade name) manufactured by Oxford Instruments Inc. was used as a nanothermal microscope. As the cantilever (probe), an AN2-200 (trade name) manufactured by Anasys Instruments Inc. was used.

After the shape of the sample was measured with 10 μm field of view in AC mode, the cantilever (probe) was positioned 5 μm to 10 μm away from the sample in the Z direction. In this state, the device was subjected to the detrend correction function in the contact mode under the conditions of a maximum applied voltage of 6V and a heating rate of 0.5 V/s to correct a change in deflection of the cantilever (probe) due to voltage application. Then, the cantilever was brought into contact with the sample in the contact mode so that the change in deflection before and after contact between the cantilever and the sample was 0.2 V. While the deflection was maintained at a constant value, a voltage was applied to the cantilever under the conditions of a maximum applied voltage of 6V and a heating rate of 0.5 V/s to heat the sample. The change in Z displacement at this time was recorded, and after the Z displacement changed from ascending to descending, the measurement was stopped when the Z displacement descended 50 nm from the change point. When the maximum applied voltage was reached before the Z displacement descended 50 nm from the change point, the maximum applied voltages at the detrend correction and at the measurement were increased by 0.5V and the measurement was repeated. The applied voltage at which the recorded Z displacement reached maximum was converted into a temperature, which was taken as the probe descending temperature. This measurement was performed at 10 points in a 10 μm field of view, and the average value was used.

In order to convert the applied voltage into temperature, polycaprolactone (melting point 60° C.), low-density polyethylene (112° C.), polypropylene (166° C.), and polyethylene terephthalate (255° C.) were measured as calibration samples, and a calibration curve of the applied voltage and the temperature was prepared. Here, the melting point was a melting peak temperature measured with a differential scanning calorimetry (DSC) under the condition of the temperature rising rate of 5° C./min. The measurement method was the same as that for the sample measurement, but the maximum applied voltages at the detrend correction and at the measurement were 3.5 V for polycaprolactone, 5.5 V for low-density polyethylene, 6.5 V for polypropylene, and 7.8 V for polyethylene terephthalate. The relationship between the melting point and the applied voltage at which the Z displacement was maximized when each calibration sample was measured was approximated with a cubic function by the least-squares method to prepare a calibration curve, and the applied voltage when the sample was measured was converted into temperature.

### Evaluation of Sealability

The laminate sample cut into a 10 cm square was folded in half with the sealant layer inside, and heat-sealed with a heat seal tester. The heat-sealing conditions were such that the upper surface sealing temperature was increased from 120° C. in 10° C. increments. The sealing surface was observed, and the temperature at which the sealing surface melted was recorded. The pressure was 0.1 MPa, the time was 1 second, and the lower surface sealing temperature was fixed at 100° C. The appearance was observed and the sealing strength was determined.

### Appearance

A: No melting on the surface, and no problem in appearance.
C: The surface melted, and a problem in appearance.

### Evaluation of Print Visibility

A printed image formed on the inner surface-side of the substrate layer was visually observed through the outer surface of the substrate layer.
A: Image not blurred, and clearly visible.
C: Image blurred and unclear.

### Example 3-2

A protective layer of 1 μm thickness was formed on the outer surface-side of the substrate layer using the same material as in Example 3-1, and then, a surface of the substrate layer on a side opposite to that having the protective layer was subjected to corona treatment. Then, with an electron beam heating type vacuum vapor deposition machine, a silicon oxide (Siox) vapor deposition layer of 40 nm thickness was formed on the corona-treated surface. Further, a coating layer, a print layer, an adhesive layer, and a sealant layer were provided in the same manner as in Example 3-1 to form a laminate, and the same evaluation as above was performed.

### Example 3-3

A protective layer of 3 μm thickness was formed on the outer surface-side of the substrate layer using the same material as in Example 3-1. Then, a silicon oxide thin film was provided in the same manner as in Example 3-2. Further, a coating layer, a print layer, an adhesive layer, and a sealant layer were provided in the same manner as in Example 3-1 to form a laminate, and the same evaluation as above was performed.

### Comparative Example 3-1

A laminate of Comparative Example 3-1 was prepared in the same manner as in Example 3-1 except that no protective layer was provided, and the same evaluation as above was performed.

### Comparative Example 3-2

A laminate of Comparative Example 3-2 was prepared in the same manner as in Comparative Example 3-1 except that the substrate layer was changed to a polyethylene film (GAP manufactured by Charter NEX films Inc., 25 μm thickness) having a probe descending temperature of 180° C. or lower, and the same evaluation as above was performed. The probe descending temperature of the substrate layer was 152° C.

Table 11 shows the results.

### Evaluation of Recyclability

The ratio of polyethylene (mass %) in the laminate of each example was calculated according to the formula (1) described above. All the laminates had the ratio of polyethylene of 90 mass % or greater, and had high recyclability.

TABLE 11

| | | Ex. 3-1 | Ex. 3-2 | Ex. 3-3 | Comp. Ex. 3-1 | Comp. Ex. 3-2 |
|---|---|---|---|---|---|---|
| Configuration | Protective layer | Yes | Yes | Yes | No | No |
| of each layer | Probe descending temperature | 203 | 203 | 203 | 203 | 152 |
| | of substrate layer (° C.) | | | | | |
| | Vapor deposition layer | No | Yes | Yes | No | Yes |
| | Print layer | Yes | Yes | Yes | Yes | Yes |
| | Sealant layer | LLDPE | LLDPE | LLDPE | LLDPE | LLDPE |
| Evaluation | Sealability | A | A | A | C | C |
| results | Print visibility | A | A | A | A | C |

As shown in Table 1, all the examples and comparative examples had high recyclability, but the laminates of Comparative Examples 3-1 and 3-2 having no protective layer had poor sealability. The laminate according to the present disclosure is found to be excellent in sealability and print visibility, and thus highly advantageous as a packaging material.

### Examples 4-1 to 4-3 and Comparative Examples 4-1 and 4-2

### Example 4-1

The outer surface-side of a polyethylene film (SMUQ manufactured by TOKYO PRINTING INK MFG. CO., LTD., 25 μm thickness), which was a substrate layer, having a probe descending temperature of 180° C. or higher was subjected to corona treatment, and then coated with polyamideimide resin (VYLOMAX HR-15ET manufactured by Toyobo Co., Ltd.) to form a protective layer of 0.5 μm thickness. The concentration of non-volatile components was 5 mass %. Next, a surface of the substrate layer on a side opposite to that having the protective layer was subjected to corona treatment, and an image was printed thereon using gravure ink to form a print layer. The probe descending temperature of the substrate layer was 211° C.

A dry lamination adhesive (TAKELAC A525/TAKENATE A52 manufactured by Mitsui Chemicals, Inc.) was applied as a first adhesive to the print layer surface on the substrate layer, and an intermediate layer was bonded thereto. The intermediate layer was formed of a polyethylene film (GAP manufactured by Charter NEX films Inc., 25 μm thickness) having a probe descending temperature of 180° C. or lower, and, on a corona-treated surface thereof on the sealant layer-side, a silicon oxide (Siox) vapor deposition layer of 40 nm thickness as a gas barrier layer was formed in advance using an electron beam heating type vacuum vapor deposition device. Further, a hybrid organic/inorganic coating solution was applied to the gas barrier layer to form a coating layer of 0.3 μm thickness. The probe descending temperature of the intermediate layer was 160° C. Further, a linear low-density polyethylene resin (LLDPE) film (TUX manufactured by Mitsui Chemicals Tohcello, Inc., 60 μm thickness) as a sealant layer was bonded using a second adhesive (same as the first adhesive) to thereby form a laminate.

### Method for Measuring Probe Descending Temperature in Examples

Details of the measurement conditions were as follows. MPF-3D-SA (trade name) manufactured by Oxford Instruments Inc. was used as the atomic force microscope, in which a Ztherm (trade name) manufactured by Oxford Instruments Inc. was used as a nanothermal microscope. As the cantilever (probe), an AN2-200 (trade name) manufactured by Anasys Instruments Inc. was used.

After the shape of the sample was measured with 10 μm field of view in AC mode, the cantilever (probe) was positioned 5 μm to 10 μm away from the sample in the Z direction. In this state, the device was subjected to the detrend correction function in the contact mode under the conditions of a maximum applied voltage of 6V and a heating rate of 0.5 V/s to correct a change in deflection of the cantilever (probe) due to voltage application. Then, the cantilever was brought into contact with the sample in the contact mode so that the change in deflection before and after contact between the cantilever and the sample was 0.2 V. While the deflection was maintained at a constant value, a voltage was applied to the cantilever under the conditions of a maximum applied voltage of 6V and a heating rate of 0.5 V/s to heat the sample. The change in Z displacement at this time was recorded, and after the Z displacement changed from ascending to descending, the measurement was stopped when the Z displacement descended 50 nm from the change point. When the maximum applied voltage was reached before the Z displacement descended 50 nm from the change point, the maximum applied voltages at the detrend correction and at the measurement were increased by 0.5V and the measurement was repeated. The applied voltage at which the recorded Z displacement reached maximum was converted into a temperature, which was taken as the probe descending temperature. This measurement was performed at 10 points in a 10 μm field of view, and the average value was used.

In order to convert the applied voltage into temperature, polycaprolactone (melting point 60° C.), low-density polyethylene (112° C.), polypropylene (166° C.), and polyethylene terephthalate (255° C.) were measured as calibration samples, and a calibration curve of the applied voltage and the temperature was prepared. Here, the melting point was a melting peak temperature measured with a differential scanning calorimetry (DSC) under the condition of the temperature rising rate of 5° C./min. The measurement method was the same as that for the sample measurement, but the maximum applied voltages at the detrend correction and at the measurement were 3.5 V for polycaprolactone, 5.5 V for low-density polyethylene, 6.5 V for polypropylene, and 7.8 V for polyethylene terephthalate. The relationship between the melting point and the applied voltage at which the Z displacement was maximized when each calibration sample was measured was approximated with a cubic function by the least-squares method to prepare a calibration curve, and the applied voltage when the sample was measured was converted into temperature.

### Recyclability

The ratio of polyethylene (mass %) in the laminate of each example was calculated according to the formula (1) described above. The evaluation was made using 2 grades below.
A: Content of polyethylene 90 mass % or greater
C: Content of polyethylene less than 90 mass %

### Evaluation of Sealability

The laminate sample cut into a 10 cm square was folded in half with the sealant layer inside, and heat-sealed with a heat seal tester. The heat-sealing conditions were such that the upper surface sealing temperature was increased from 120° C. in 10° C. increments. The sealing surface was observed, and the temperature at which the sealing surface melted was recorded. The pressure was 0.1 MPa, the time was 1 second, and the lower surface sealing temperature was fixed at 100° C. The appearance was observed and the sealing strength was determined. In the laminate according to Example 4-1, the sealing surface melted at 140° C.

### Appearance

A: No melting on the surface, and no problem in appearance.
C: The surface melted, and a problem in appearance.

### Evaluation of Visibility

A printed image formed on the inner surface-side of the substrate layer was visually observed through the outer surface of the substrate layer.
A: Image not blurred, and clearly visible.
C: Image blurred and unclear.

### Evaluation of Drop Strength

Using the laminate, 10 packaging bags of 100 mm×150 mm with heat-sealed peripheral edges were produced. The packaging bags were filled with 200 ml of tap water, sealed by heat-sealing, and stored at 5° C. for 1 day. Then, the packaging bags were dropped 50 times from the height of 1.5 m, and the number of packaging bags broken was recorded.

### Example 4-2

A protective layer of 1 μm thickness was formed on the outer surface-side of the substrate layer using the same material as in Example 4-1. Then, a silicon oxide thin film, a coating layer, a print layer, an adhesive layer, and a sealant layer were provided in the same manner as in Example 4-1 to form a laminate, and the same evaluation as above was performed. In the evaluation of sealability, the laminate according to Example 4-2 was found that the sealing surface melted at 150° C.

### Example 4-3

A protective layer of 3 μm thickness was formed on the outer surface-side of the substrate layer using the same material as in Example 4-1. Then, a silicon oxide thin film, a coating layer, a print layer, an adhesive layer, and a sealant layer were provided in the same manner as in Example 4-1 to form a laminate, and the same evaluation as above was performed. In the evaluation of sealability, the laminate according to Example 4-3 was found that the sealing surface melted at 170° C.

### Comparative Example 4-1

A laminate of Comparative Example 4-1 was prepared, in which a substrate layer and an intermediate layer were provided using a polyethylene film (SMUQ manufactured by TOKYO PRINTING INK MFG. CO., LTD., 25 μm thickness) having a probe descending temperature of 180° C. or higher, which was the same as the substrate layer of Example 4-1. In the laminate, a print layer and a gas barrier layer were formed in the same manner as in Example 4-1, and no protective layer was provided on the outer surface-side of the substrate layer. Then, the same evaluation as above was performed. The probe descending temperature of the substrate layer and the intermediate layer was 211° C. In the evaluation of sealability, the laminate according to Comparative Example 4-1 was found that the sealing surface melted down at 130° C.

### Comparative Example 4-2

A laminate of Comparative Example 4-2 was prepared in the same manner as in Comparative Example 4-1 except that the substrate layer was changed to a polyethylene film (GAP manufactured by Charter NEX films Inc., 25 μm thickness) having a probe descending temperature of 180° C. or lower, and the same evaluation as above was performed. The probe descending temperature of the substrate layer was 160° C. In the evaluation of sealability, the laminate according to Comparative Example 4-2 was found that the sealing surface melted down at 130° C.

Table 12 shows the results.

TABLE 12

| | | Ex. 4-1 | Ex. 4-2 | Ex. 4-3 | Comp. Ex. 4-1 | Comp. Ex. 4-2 |
|---|---|---|---|---|---|---|
| Configura- | Thickness of protective layer | 0.5 | 1 | 3 | No | No |
| tion of | (μm) | | | | | |
| each | Substrate layer | Tokyo Printing | Tokyo Printing | Tokyo Printing | Tokyo Printing | Charter NEX |
| layer | | Ink | Ink | Ink | Ink | GAP |
| | | SMUQ | SMUQ | SMUQ | SMUQ | |
| | Probe descending temperature of | 211 | 211 | 211 | 211 | 160 |
| | substrate layer (° C.) | | | | | |
| | Haze of substrate layer (%) | 1.6 | 1.6 | 1.6 | 1.6 | 21.5 |
| | Print layer | Yes | Yes | Yes | Yes | Yes |
| | First adhesive layer | Urethane- | Urethane- | Urethane- | Urethane- | Urethane- |
| | | based | based | based | based | based |
| | | adhesive | adhesive | adhesive | adhesive | adhesive |
| | Intermediate layer | Charter NEX | Charter NEX | Charter NEX | Tokyo Printing | Tokyo Printing |
| | | GAP | GAP | GAP | Ink | Ink |
| | | | | | SMUQ | SMUQ |
| | Probe descending temperature of | 160 | 160 | 160 | 211 | 211 |
| | intermediate layer (° C.) | | | | | |
| | Haze of intermediate layer (%) | 21.5 | 21.5 | 21.5 | 1.6 | 1.6 |
| | Inorganic compound layer | Silica | Silica | Silica | Silica | Silica |
| | Gas barrier coating layer | Yes | Yes | Yes | Yes | Yes |
| | Second adhesive layer | Urethane- | Urethane- | Urethane- | Urethane- | Urethane- |
| | | based | based | based | based | based |
| | | adhesive | adhesive | adhesive | adhesive | adhesive |
| | Sealant layer | LLDPE | LLDPE | LLDPE | LLDPE | LLDPE |
| | Recyclability | A | A | A | A | A |
| Evaluation | Ratio of polyethylene (mass %) | 92 | 92 | 92 | 92 | 92 |
| results | Sealability | A | A | A | C | C |
| | Visibility | A | A | A | A | C |
| | Drop strength (Number of broken | 0 | 0 | 0 | 8 | 7 |
| | bags) | | | | | |

As shown in Table 12, all the examples and comparative examples had high recyclability, but the laminates of Comparative Examples 4-1 and 4-2 having no protective layer had poor sealability. The laminate according to the present disclosure is found to be excellent in sealability, print visibility and drop impact, and thus highly advantageous as a packaging material.

### Examples 5-1 to 5-3 and Comparative Examples 5-1 and 5-2

### Example 5-1

The outer surface-side of a polyethylene film (SMUQ manufactured by TOKYO PRINTING INK MFG. CO., LTD., 25 μm thickness), which was a substrate layer, having a probe descending temperature of 180° C. or higher was subjected to corona treatment, and then coated with polyamideimide resin (VYLOMAX HR-15ET manufactured by Toyobo Co., Ltd.) to form a protective layer of 0.5 μm thickness. The concentration of non-volatile components was 5 mass %. Next, a surface of the substrate layer on a side opposite to that having the protective layer was subjected to corona treatment, and an image was printed thereon using gravure ink to form a print layer.

Next, a dry lamination adhesive (TAKELAC A525/TAKENATE A52 manufactured by Mitsui Chemicals, Inc.) was applied as a first adhesive to the print layer surface on the substrate layer, and an intermediate layer was bonded thereto. The intermediate layer was formed of the same polyethylene film as the substrate layer, and, on a corona-treated surface thereof on the sealant layer-side, a silicon oxide (Siox) vapor deposition layer of 40 nm thickness as a gas barrier layer was formed in advance using an electron beam heating type vacuum vapor deposition device. Further, a hybrid organic/inorganic coating solution was applied to the gas barrier layer to form a coating layer of 0.3 μm thickness. The probe descending temperature of the substrate layer and the intermediate layer was 211° C. Further, a linear low-density polyethylene resin (LLDPE) film (TUX manufactured by Mitsui Chemicals Tohcello, Inc., 60 μm thickness) as a sealant layer was bonded using a second adhesive (same as the first adhesive) to thereby form a laminate.

### Method for Measuring Probe Descending Temperature in Examples

Details of the measurement conditions were as follows. MPF-3D-SA (trade name) manufactured by Oxford Instruments Inc. was used as the atomic force microscope, in which a Ztherm (trade name) manufactured by Oxford Instruments Inc. was used as a nanothermal microscope. As the cantilever (probe), an AN2-200 (trade name) manufactured by Anasys Instruments Inc. was used.

After the shape of the sample was measured with 10 μm field of view in AC mode, the cantilever (probe) was positioned 5 μm to 10 μm away from the sample in the Z direction. In this state, the device was subjected to the detrend correction function in the contact mode under the conditions of a maximum applied voltage of 6V and a heating rate of 0.5 V/s to correct a change in deflection of the cantilever (probe) due to voltage application. Then, the cantilever was brought into contact with the sample in the contact mode so that the change in deflection before and after contact between the cantilever and the sample was 0.2 V. While the deflection was maintained at a constant value, a voltage was applied to the cantilever under the conditions of a maximum applied voltage of 6V and a heating rate of 0.5 V/s to heat the sample. The change in Z displacement at this time was recorded, and after the Z displacement changed from ascending to descending, the measurement was stopped when the Z displacement descended 50 nm from the change point. When the maximum applied voltage was reached before the Z displacement descended 50 nm from the change point, the maximum applied voltages at the detrend correction and at the measurement were increased by 0.5V and the measurement was repeated. The applied voltage at which the recorded Z displacement reached maximum was converted into a temperature, which was taken as the probe descending temperature. This measurement was performed at 10 points in a 10 μm field of view, and the average value was used.

In order to convert the applied voltage into temperature, polycaprolactone (melting point 60° C.), low-density polyethylene (112° C.), polypropylene (166° C.), and polyethylene terephthalate (255° C.) were measured as calibration samples, and a calibration curve of the applied voltage and the temperature was prepared. Here, the melting point was a melting peak temperature measured with a differential scanning calorimetry (DSC) under the condition of the temperature rising rate of 5° C./min. The measurement method was the same as that for the sample measurement, but the maximum applied voltages at the detrend correction and at the measurement were 3.5 V for polycaprolactone, 5.5 V for low-density polyethylene, 6.5 V for polypropylene, and 7.8 V for polyethylene terephthalate. The relationship between the melting point and the applied voltage at which the Z displacement was maximized when each calibration sample was measured was approximated with a cubic function by the least-squares method to prepare a calibration curve, and the applied voltage when the sample was measured was converted into temperature.

### Recyclability

The ratio of polyethylene (mass %) in the laminate of each example was calculated according to the formula (1) described above. The evaluation was made using 2 grades below.
A: Content of polyethylene 90 mass % or greater
C: Content of polyethylene less than 90 mass %

### Evaluation of Sealability

The laminate sample cut into a 10 cm square was folded in half with the sealant layer inside, and heat-sealed with a heat seal tester. The heat-sealing conditions were such that the upper surface sealing temperature was increased from 120° C. in 10° C. increments. The sealing surface was observed, and the temperature at which the sealing surface melted was recorded. The pressure was 0.1 MPa, the time was 1 second, and the lower surface sealing temperature was fixed at 100° C. The appearance was observed and the sealing strength was determined. In the laminate according to Example 5-1, the sealing surface melted at 140° C.

### Appearance

A: No melting on the surface, and no problem in appearance.
C: The surface melted, and a problem in appearance.

### Evaluation of Visibility

A printed image formed on the inner surface-side of the substrate layer was visually observed through the outer surface of the substrate layer.
A: Image not blurred, and clearly visible.
C: Image blurred and unclear.

### Puncture Strength

Puncture strength was measured according to JIS Z 1707:2019. While the laminate of each example was held flat under tension, a needle with a 1.0 mm diameter and a hemispherical tip of 0.5 mm radius was pressed against the substrate-side of the laminate at 50 mm/min to measure the amount of force (Newton: N) when piercing the laminate.

### Example 5-2

A protective layer of 1 μm thickness was formed on the outer surface-side of the substrate layer using the same material as in Example 5-1. Then, a silicon oxide thin film, a coating layer, a print layer, an adhesive layer, and a sealant layer were provided in the same manner as in Example 5-1 to form a laminate, and the same evaluation as above was performed. In the evaluation of sealability, the laminate according to Example 5-2 was found that the sealing surface melted at 150° C.

### Example 5-3

A protective layer of 3 μm thickness was formed on the outer surface-side of the substrate layer using the same material as in Example 5-1. Then, a silicon oxide thin film, a coating layer, a print layer, an adhesive layer, and a sealant layer were provided in the same manner as in Example 5-1 to form a laminate, and the same evaluation as above was performed. In the evaluation of sealability, the laminate according to Example 5-3 was found that the sealing surface melted at 170° C.

### Comparative Example 5-1

A laminate of Comparative Example 5-1 was prepared, in which a substrate layer was provided using a polyethylene film (GAP manufactured by Charter NEX films Inc., 25 μm thickness) having a probe descending temperature of 180° C. or lower, which was the same as the substrate layer of Example 5-1. In the laminate, a print layer and a gas barrier layer were formed in the same manner as in Example 5-1, and no protective layer was provided on the outer surface-side of the substrate layer. Then, the same evaluation as above was performed. The probe descending temperature of the intermediate layer was 160° C. In the evaluation of sealability, the laminate according to Comparative Example 5-1 was found that the sealing surface melted down at 130° C.

### Comparative Example 5-2

A laminate of Comparative Example 5-2 was prepared in the same manner as in Comparative Example 5-1 except that the substrate layer was changed to a polyethylene film (GAP manufactured by Charter NEX films Inc., 25 μm thickness) having a probe descending temperature of 180° C. or lower, and the same evaluation as above was performed. The probe descending temperature of the substrate layer was 160° C. In the evaluation of sealability, the laminate according to Comparative Example 5-2 was found that the sealing surface melted down at 130° C.

Table 13 shows the results.

TABLE 13

| | | Ex. 5-1 | Ex. 5-2 | Ex. 5-3 | Comp. Ex. 5-1 | Comp. Ex. 5-2 |
|---|---|---|---|---|---|---|
| Configuration | Thickness of protective layer | 0.5 | 1 | 3 | No | No |
| of each layer | (μm) | | | | | |
| | Substrate layer | Tokyo Printing | Tokyo Printing | Tokyo Printing | Tokyo Printing | Charter NEX |
| | | Ink | Ink | Ink | Ink | GAP |
| | | SMUQ | SMUQ | SMUQ | SMUQ | |
| | Probe descending temperature of | 211 | 211 | 211 | 211 | 160 |
| | substrate layer (° C.) | | | | | |
| | Haze of substrate layer (%) | 1.6 | 1.6 | 1.6 | 1.6 | 21.5 |
| | Print layer | Yes | Yes | Yes | Yes | Yes |
| | First adhesive layer | Urethane-based | Urethane-based | Urethane-based | Urethane-based | Urethane-based |
| | | adhesive | adhesive | adhesive | adhesive | adhesive |
| | Intermediate layer | Tokyo Printing | Tokyo Printing | Tokyo Printing | Charter NEX | Charter NEX |
| | | Ink | Ink | Ink | GAP | GAP |
| | | SMUQ | SMUQ | SMUQ | | |
| | Probe descending temperature of | 211 | 211 | 211 | 160 | 160 |
| | intermediate layer (° C.) | | | | | |
| | Haze of intermediate layer (%) | 1.6 | 1.6 | 1.6 | 21.5 | 21.5 |
| | Inorganic compound layer | Silica | Silica | Silica | Silica | Silica |
| | Gas barrier coating layer | Yes | Yes | Yes | Yes | Yes |
| | Second adhesive layer | Urethane-based | Urethane-based | Urethane-based | Urethane-based | Urethane-based |
| | | adhesive | adhesive | adhesive | adhesive | adhesive |
| | Sealant layer | LLDPE | LLDPE | LLDPE | LLDPE | LLDPE |
| | Recyclability | A | A | A | A | A |
| Evaluation | Ratio of polyethylene (mass %) | 92 | 92 | 92 | 92 | 92 |
| results | Sealability | A | A | A | C | C |
| | Visibility | A | A | A | A | C |
| | Puncture strength (N) | 9.6 | 9.6 | 9.6 | 7.5 | 5 |

As shown in Table 13, all the examples and comparative examples had high recyclability, but the laminates of Comparative Examples 5-1 and 5-2 having no protective layer had poor sealability. The laminate according to the present invention is found to be excellent in sealability, print visibility and puncture strength, and thus highly advantageous as a packaging material.

### REFERENCE SIGNS LIST

1, 2 . . . Laminate; 10 . . . Substrate layer; 10a . . . Outer surface of substrate layer; 10b . . . Inner surface of substrate layer; 11 . . . Protective layer; 12 . . . Printed layer; 14 . . . Vapor deposition layer; 15 . . . Gas barrier coating layer; 20 . . . Intermediate layer; 30 . . . Sealant layer; 40 . . . First adhesive layer; 50, 60 . . . Second adhesive layer.

What is claimed is:

1. A laminate, comprising:
a protective layer;
a substrate layer; and
a sealant layer, laminated in this order, wherein
the substrate layer and the sealant layer contain polyethylene,
the protective layer contains a thermosetting resin or a resin having a melting point of 160° C. or higher, and
a ratio of polyethylene in the laminate is 90 mass % or greater.

2. The laminate of claim 1, comprising
a vapor deposition layer between the substrate layer and the sealant layer.

3. The laminate of claim 2, wherein
the vapor deposition layer contains a metal oxide.

4. The laminate of claim 1, wherein
the protective layer contains at least one resin selected from the group consisting of polyurethane, polyester, polyamide, polyamideimide and epoxy.

5. The laminate of claim 1, wherein
the protective layer has a thickness of 0.4% or more and 2.0% or less of a total thickness of the laminate.

6. The laminate of claim 1, wherein
at least one of the substrate layer and the sealant layer is a layer formed of an unstretched polyethylene film.

7. The laminate of claim 1, comprising
an intermediate layer between the substrate layer and the sealant layer, the intermediate layer containing polyethylene.

8. The laminate of claim 7, wherein
the intermediate layer contains high-density polyethylene or medium-density polyethylene.

9. The laminate of claim 7, wherein
the intermediate layer is a layer formed of an unstretched polyethylene film.

10. A laminate, comprising:
a substrate layer;
a first adhesive layer;
an intermediate layer;
a second adhesive layer;
a sealant layer, laminated in this order, and
a protective layer laminated on an outermost side of the substrate layer, wherein
the protective layer is made of a thermosetting resin,
the substrate layer is a stretched polyethylene film,
the intermediate layer and the sealant layer are unstretched polyethylene films,
a vapor deposition layer is disposed on one surface of the intermediate layer, and
a ratio of polyethylene in the laminate is 90 wt % or more.

11. The laminate of claim 10, wherein
the thermosetting resin is formed of a cured product of one or more resin compositions of urethane, polyester, polyamide, acrylic, and epoxy.

12. The laminate of claim 10, wherein
the vapor deposition layer contains a metal oxide.

13. The laminate of claim 10, wherein
the intermediate layer contains high-density polyethylene or medium-density polyethylene.

14. The laminate of claim 1, wherein
the substrate layer contains high-density polyethylene or medium-density polyethylene.

15. The laminate of claim 1, wherein
the sealant layer contains low-density polyethylene.

16. A laminate, comprising: at least a substrate layer and a sealant layer, wherein
a protective layer is provided on at least one surface of the substrate layer,
each of the substrate layer and the sealant layer are made of polyethylene (PE) resin,
the substrate layer has a probe descending temperature of 180° C. or higher, and
a ratio of polyethylene in the laminate is 90 mass % or more.

17. The laminate of claim 16, further comprising
an intermediate layer made of polyethylene (PE) resin.

18. The laminate of claim 17, wherein
the intermediate layer has a probe descending temperature of 180° C. or lower.

19. The laminate of claim 17, wherein
the intermediate layer has a probe descending temperature of 180° C. or higher.

20. The laminate of claim 16, wherein
the protective layer, the substrate layer, an adhesive layer, and the sealant layer are disposed in this order, and
the laminate further comprising a vapor deposition layer on at least one surface of the substrate layer.

21. The laminate of claim 17, wherein
the protective layer, the substrate layer, a first adhesive layer, the intermediate layer, a second adhesive layer, and the sealant layer are disposed in this order, and
the laminate further comprising a vapor deposition layer on at least one surface of the intermediate layer.

22. The laminate of claim 20, wherein
the vapor deposition layer is composed of an inorganic compound layer, or composed of an inorganic compound layer and a coating layer.

23. The laminate of claim 22, wherein
the coating layer contains a hydroxyl group-containing polymer and an organic silicon compound.

24. The laminate of claim 16, wherein
the protective layer contains one or more of urethane resin, polyester resin, polyamide resin, acrylic resin, and epoxy resin, and has a thickness of 0.3 μm or more and 3 μm or less.

25. A packaging material comprising the laminate of claim 1.

26. A packaging bag using the laminate of claim 1, wherein
the sealant layer has a thickness of 20 μm or more and 150 μm or less.
